(19) United States
(12) Patent Application Publication
(10) Pub. No.: US 2026/0054596 A1
(43) Pub. Date: Feb. 26, 2026

(54) SYSTEM AND METHOD OF COMMUNICATION WITH CHARGING STATION TO IDENTIFY DISCHARGE OPPORTUNITY

(71) Applicant: Volvo Car Corporation, Göteborg (SE)

(72) Inventors: Andreas ROPEL, TORSLANDA (SE); Jones SCHÖLD, Göteborg (SE); Fredrik HAAK, Ödsmål (SE); Ali FOTOUHI, Kungsbacka (SE); Virat ANDODARIYA, Göteborg (SE); Vijay ARUMUGAM, Göteborg (SE)

(73) Assignee: Volvo Car Corporation, Göteborg (SE)

(21) Appl. No.: 18/810,690

(22) Filed: Aug. 21, 2024

(51) Int. Cl. B60L 53/66; B60L 53/62; B60L 53/63; B60L 53/68; B60L 55/00

(52) U.S. Cl. CPC B60L 53/665; B60L 53/62; B60L 53/63; B60L 53/68; B60L 55/00

(57) ABSTRACT

Embodiments relate to a system and method of communication with charging station to identify discharge opportunity. The system comprising: a processor operatively coupled to a memory storing instructions which on execution cause the processor to: establish communication with one or more charging stations at a geographical location; obtain, from the one or more charging stations, a first message associated with opportunities for charging and discharging a vehicle battery with the one or more charging stations; determine one or more parameters associated with the vehicle battery; select a charging station from the one or more charging stations based on the first message and the one or more parameters; and schedule a connection with the charging station to perform at least one of charging and discharging the vehicle battery to maximize a monetary gain.

### FIELD OF INVENTION

This disclosure relates to the field of vehicle to grid communication. The disclosure is more particularly related to communicating with a charging station to identify discharge opportunity.

### BACKGROUND

To obtain monetary gain for either giving away excessively stored charge in a vehicle battery back to the energy source/grid or heating the battery, a proper communication between the vehicle system and the energy source/charging station/grid is needed.

Therefore, there is a need for a system and method of communication with charging station to identify discharge opportunity.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect the present disclosure relates to a system comprising: a processor operatively coupled to a memory storing instructions which on execution cause the processor to: establish communication with one or more charging stations at a geographical location; obtain, from the one or more charging stations, a first message associated with opportunities for charging and discharging a vehicle battery with the one or more charging stations; determine one or more parameters associated with the vehicle battery; select a charging station from the one or more charging stations based on the first message and the one or more parameters; and schedule a connection with the charging station to perform at least one of charging and discharging the vehicle battery to maximize a monetary gain.

In another aspect, the present disclosure relates to a method comprising: establishing, by a processor, communication with one or more charging stations at a geographical location; obtaining, by the processor, from the one or more charging stations, a first message associated with opportunities for charging and discharging a vehicle battery with the one or more charging stations; determining, by the processor, one or more parameters associated with the vehicle battery; selecting, by the processor, a charging station from the one or more charging stations based on the first message and the one or more parameters; and scheduling, by the processor, a connection with the charging station to perform at least one of charging and discharging the vehicle battery to maximize a monetary gain.

In one another aspect, the present disclosure relates to a non-transitory computer-readable medium having stored thereon instructions executable by a processor to perform operations comprising: establishing communication with one or more charging stations at a geographical location; obtaining from the one or more charging stations, a first message associated with opportunities for charging and discharging a vehicle battery with the one or more charging stations; determining one or more parameters associated with the vehicle battery; selecting a charging station from the one or more charging stations based on the first message and the one or more parameters; and scheduling a connection with the charging station to perform at least one of charging and discharging the vehicle battery to maximize a monetary gain.

### BRIEF DESCRIPTION OF THE FIGURES

FIG. 1 illustrates a network diagram for vehicle to grid discharging according to an embodiment.

FIG. 2A illustrates a block diagram of a system associated with a vehicle according to an embodiment.

FIG. 2B shows a block diagram of a battery unit according to an embodiment.

FIG. 2C illustrates a functional block diagram of an on-board charger in the battery unit according to an embodiment.

FIG. 2D illustrates a block diagram of electronic components of the vehicle according to an embodiment.

FIG. 3A illustrates a message flow diagram between the vehicle and a charging station according to an embodiment.

FIG. 3B illustrates a message flow diagram between the vehicle and the charging station according to another embodiment.

FIG. 3C illustrates a format of a request message from the vehicle to the charging station according to an embodiment.

FIG. 3D illustrates a format of a first message from the charging station to the vehicle according to an embodiment.

FIG. 3E illustrates a format of a second message from the vehicle to the charging station according to an embodiment.

FIG. 3F illustrates a format of a third message from the charging station to the vehicle according to an embodiment.

FIG. 4 illustrates an example block diagram for an Artificial Intelligence and Machine Learning (AI/ML) model used in a system for discharging based on monetization opportunity according to an embodiment.

FIG. 5A illustrates a structure of the neural network/machine learning model with a feedback loop according to an embodiment.

FIG. 5B illustrates a structure of the neural network/machine learning model with reinforcement learning according to an embodiment.

FIG. 6 illustrates a flow chart describing a method for discharging or charging the vehicle battery based on monetization opportunity according to an embodiment.

FIG. 7 illustrates a block diagram of the system implementing the method for discharging or charging the vehicle battery based on monetization opportunity according to an embodiment.

FIG. 8 illustrates a block diagram of the method executed by the non-transitory computer-readable medium for discharging or charging the vehicle battery based on monetization opportunity according to an embodiment.

FIG. 9 illustrates a flow chart describing a method to determine a scheme to heat the vehicle battery for optimal performance according to an embodiment.

FIG. 10 illustrates a block diagram of the system implementing the method to determine a scheme to heat the vehicle battery for optimal performance according to an embodiment.

FIG. 11 illustrates a block diagram of the method executed by the non-transitory computer-readable medium for heating the battery for optimal performance according to an embodiment.

FIG. 12 illustrates a flow chart describing a method of communication with a charging station to identify discharge or charge opportunities according to an embodiment.

FIG. 13 illustrates a block diagram of the system implementing the method of communication with a charging station to identify discharge or charge opportunity according to an embodiment.

FIG. 14 illustrates a block diagram of the method executed by the non-transitory computer-readable medium for communicating with a charging station to identify discharge or charge opportunity according to an embodiment.

FIG. 15A illustrates the block diagram of the cyber security module in view of the system and server according to an embodiment.

FIG. 15B illustrates an embodiment of the cyber security module according to an embodiment.

FIG. 15C illustrates another embodiment of the cyber security module according to an embodiment.

FIG. 16 illustrates a block diagram of a system for discharging or charging the vehicle battery based on monetization opportunity according to an embodiment.

FIG. 17 illustrates a block diagram of a system to heat the vehicle battery for an optimal performance according to an embodiment

### DETAILED DESCRIPTION

### Definitions and General Techniques

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more. ” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through/dio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware. In an example, the second component can be an energy source capable of charging a vehicle battery and accepting charge from the vehicle battery.

The term “alert” or “alert signal” refers to a communication to attract attention. An alert may include visual, tactile, audible alert and a combination of these alerts to warn the user of the vehicle. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles'computer or vehicles'central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users'applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The term “vehicle system” or “system of a vehicle” or “system associated with a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The term “battery” as used herein refers to a battery system in the vehicle, wherein the battery system may be used for starting the vehicle or may be used for operating the vehicle. The battery system may also be used to enable the vehicle to run.

The term “charging station” as used herein refers to an energy source supplying power for the vehicle to function. In some embodiments, the charging station may be connected to a grid. The charging station may supply energy from the grid to the vehicle. In some embodiments, the charging station may comprise a charge storage device for storing charge in a larger quantity and discharge the stored charge to the vehicle when needed.

The term “charge” or “battery charge” or “charge level” or “state of charge (SoC)” as used herein refers to the amount of energy in the battery relative to a capacity of the battery. Charge in general is expressed as a percentage, wherein 100% indicates a fully charged battery and 0% indicates a completely discharged battery. Further, “charging” or “battery charging” or “charge the battery” refers to the process of replenishing the energy stored in the battery by applying an electric current to the battery. In some embodiments, the battery may be connected to a charger and the charging process converts the electrical energy from the charger into chemical energy in the battery.

The term “discharge” or “battery discharge” as used herein refers to the amount of energy supplied by the battery to a load such as, without limitations, a device or another battery or an energy source (for e.g., grid). Further, “discharging” or “battery discharging” or “discharge the battery” refers to the process of extracting the energy stored from the battery. The discharging process converts the chemical energy from the battery into an electrical energy that may be supplied to any load connected to the battery.

The term “charge current” as used herein refers to the electrical current applied to the battery during the charging process. The charge current flows into the battery from an external power source, such as a charger or power supply, and is used to replenish the energy stored in the battery's cells. The charge current is measured in amperes (A).

The term “discharge current” as used herein refers to the electrical current drawn from the battery during its operation. The discharge current flow occurs from the battery to an external load to supply power to the load. The discharge current is measured in amperes (A).

The term “battery efficiency” or “efficiency of the battery” as used herein refers to how effectively the battery converts the stored energy into a useful energy.

The term “battery age” or “age of the battery” or “age of the vehicle battery” as used herein refers to a length of time since the battery was manufactured. The age of the battery may be affected by various factors, for example, the number of complete charging and discharging cycles undergone by the battery and the temperature associated with an operating environment.

The term “threshold charge level” as used herein refers to a minimum battery charge level required by the vehicle to reach a travel destination.

The term “peak time” or “peak period” or “peak duration” as used herein refers to a time of the day during which the energy source or the grid or the charging station may be overloaded due to higher energy demand. In such times, the energy source or the charging station or the grid may require energy from external sources and may be ready to pay for the required energy.

The term “valley time” or “valley period” or “valley duration” as used herein refers to a time of the day during which the energy source or the grid or the charging station may have lesser energy demand. In such times, the energy source or the charging station or the grid may be ready to provide energy to vehicles or devices at a very less cost.

The term “monetary value” as used herein refers to the pricing, i.e., amount per unit of charge, provided by the energy source or the charging station or the grid for getting external energy, for example, vehicle batteries or energy storage units.

The term “monetary gain” as used herein refers to the profit obtained by the user of the vehicle by charging or discharging the vehicle battery.

The term “monetary opportunity” or “monetization opportunity” as used herein refers to possibilities of achieving monetary gain by heating the vehicle battery or by discharging the vehicle battery.

The term “monitoring” as used herein refers to systematic observation and assessment of a system, process, or environment in real-time or near real-time. It involves the regular collection, analysis, and interpretation of data using various sensors. Monitoring may be continuous or adaptive. In some embodiments, monitoring may be performed on the status of the battery, for example, temperature of the battery and a charge level of the battery.

The term “operating efficiency” or “work efficiency” refers to the optimal performance level of the battery in terms of power output, energy efficiency, and charging speed.

The term “peak performance temperature” as used herein refers to the temperature of the battery at which the battery's operating efficiency or work efficiency is maximized.

The term “scheme” as used herein refers to heating the battery by either charging the battery or discharging the battery.

The term “weather conditions” as used herein refers to atmospheric or meteorological state at a specific location and time. The weather conditions may include factors such as, not limited to, temperature, humidity, wind speed, precipitation (rain, snow, etc.), cloud cover, visibility, and atmospheric pressure.

The term “physical conditions” as used herein refers to the condition of the road (broad, narrow, smooth, bumpy, etc.), traffic intensity, diversions, number of traffic signals, etc., along a travel route.

The term “user” as used herein refers to any individual who is a driver or an owner of the vehicle. Broadly, it may encompass any individual having the possession of the vehicle.

Vehicles, majorly used for commuting, require energy for their operation. A vehicle includes a power generation system comprising an alternator and a voltage converter for supplying an operational voltage to one or more of its components. In addition to the power generation system, the vehicle also includes a plurality of battery packs for its operation. The battery packs are capable of storing the energy generated by the power generation system and assist in starting the vehicle and operation of the vehicle. Further, the battery packs can also be charged by plugging-in the vehicle to a charging station or an energy source. The battery packs are also capable of discharging back to the energy source.

With growing need and interest towards green energy and sustainable energy, discharging from the vehicle, i.e., the vehicle battery packs, back to the energy source is gaining more interest. Further, the vehicle owners also benefit monetarily by providing the charge back to the energy source, for example, the grid. During a travel from a source to destination the vehicle may at times be at a stopover location. The user of the vehicle may use the stopover time to make money by giving energy back to the energy source or grid.

Business Problem1: Every user expects a maximum monetary gain by giving away excessively stored charge in a vehicle battery back to the energy source/grid. In a particular geographical location, there may be one or more energy sources or charging stations that may want the charge from the vehicle battery. However, the user may not be aware of connecting to which of the energy sources that will provide a maximum monetary gain.

Technical Problem1: Currently, when a driver or user of the vehicle takes a break at a stopover location, the vehicle is in a parked condition and there is no method to determine if the energy source around the stopover location has a charge requirement and, hence, could provide a monetization opportunity associated with the charge requirement.

Business Solution1: Establishing communication with one or more charging stations in a geographical location and determining a discharging opportunity to maximize the monetary gain.

Technical Solution1: In one aspect, the present disclosure discusses a system and method for discharging based on monetization opportunity. The system may determine the presence of one or more energy sources around the stopover location and may initiate a communication with the energy sources to check for charge requirements. The system may then determine which of the energy sources is providing a maximum pricing for discharging and connect to that particular energy source for discharging to maximize monetary gain. Alternatively, if the pricing provided by the energy source for discharging is less, the system may check for the pricing quoted for charging. If the price quoted for charging is very less the system may determine to fully charge the vehicle battery so that the vehicle battery may be discharged later to maximize monetary gain. In both ways, the user gets monetary benefit.

In an aspect, the present disclosure relates to a system comprising: a processor operatively coupled to a memory storing instructions which on execution cause the processor to: establish communication with one or more charging stations at a geographical location; receive, from the one or more charging stations, a monetary value associated with at least one of charging a vehicle battery and discharging the vehicle battery; select at least one charging station of the one or more charging stations at the geographical location based on the monetary value; and perform at least one of charging the vehicle battery and discharging the vehicle battery with the at least one charging station to maximize a monetary gain.

In another aspect, the present disclosure relates to a method comprising: establishing, by a processor, communication with one or more charging stations at a geographical location; receiving, by the processor, from the one or more charging stations, a monetary value associated with at least one of charging a vehicle battery and discharging the vehicle battery; selecting, by the processor, at least one charging station of the one or more charging stations at the geographical location based on the monetary value; and performing, by the processor, at least one of charging the vehicle battery and discharging the vehicle battery with the at least one charging station to maximize a monetary gain.

In yet another aspect, the present disclosure relates to a non-transitory computer-readable medium having stored thereon instructions executable by a processor to perform operations comprising: establishing communication with one or more charging stations at a geographical location; receiving, from the one or more charging stations, a monetary value associated with at least one of charging a vehicle battery and discharging the vehicle battery; selecting at least one charging station of the one or more charging stations at the geographical location based on the monetary value; and performing at least one of charging the vehicle battery and discharging the vehicle battery with the at least one charging station to maximize a monetary gain.

Technical Result1: Discharging or charging based on the pricing information and selecting the energy source providing the maximum monetary value, enables the user associated with the vehicle to maximize a monetary gain.

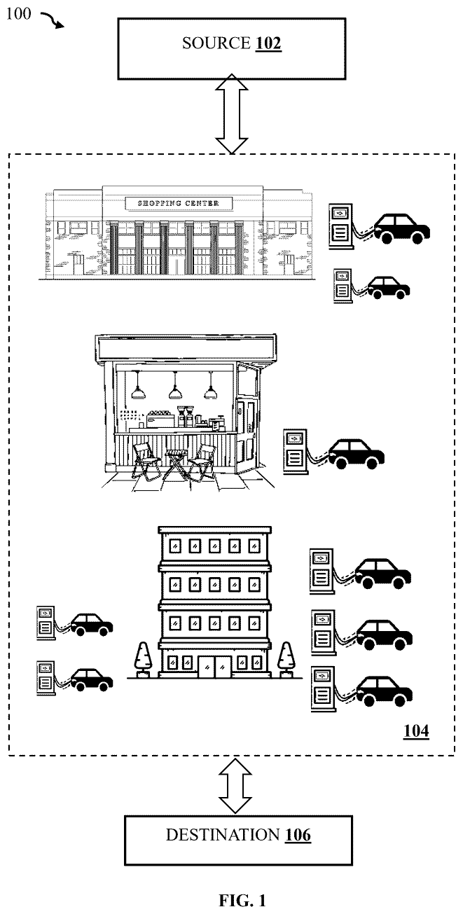

Technical Details Specific to the Technical Solution1: FIG. 1 illustrates network 100 describing a travel route for a vehicle from source 102 to destination 106. The travel route may comprise stopover location 104. The stopover location may comprise a location where the vehicle is in a stationary state, i.e., a parked condition. In some embodiments, the location may comprise a resting place, a dining place, a parking place, a shopping area, a medical center, a workshop etc., at a particular geographical location along the travel route. In an embodiment, the vehicle traveling from source 102 to destination 106 may receive a command from the driver or user of the vehicle to take a break at one of the stopover locations. Upon receiving the command, a vehicle system or a system associated with the vehicle may establish communication with one or more energy sources or charging stations around the stopover location. Further, the system determines which of the energy sources is providing the best monetary value for discharging. The system may then direct the vehicle to connect to the energy source providing the best monetary value and start discharging the vehicle's battery. In some embodiments, the user may select a first stopover location and the system may determine that an energy source at a second stopover location provides a better monetary value. The system informs the user to change the stopover location to obtain maximum monetary gain by discharging the vehicle battery.

Referring to FIG. 1, in some embodiments if the monetary value provided for discharging is not satisfactory, the system may request for a monetary value associated with charging. If the price per unit of charge quoted by the energy source is very low, the system may opt to charge the battery to full capacity. The system keeps looking for an increase in monetary opportunities associated with discharging and discharges when there is an increase in the monetary value provided for discharging. In some embodiments, the monetary value provided for discharging may be compared with a first predefined value and the monetary value quoted for charging may be compared with a second predefined value. In some embodiments, the system also determines the available level of charge in the vehicle battery prior to establishing communication with the energy source at the stopover location. Based on the level of charge the system may perform either discharging to achieve monetary gain or charging to increase the level of charge in the vehicle battery.

How Technical Solution 1 is a Technological Advancement: The present disclosure discusses techniques for maximizing profit for a user of the vehicle by both charging the battery and discharging the battery. The profit maximization scheme will encourage more users to opt for vehicles working independent of fossil fuel.

Business problem 2: To obtain peak power or optimal performance from the battery, the battery should be at a certain temperature. Pre-heating the battery uses some energy of the battery.

Technical problem 2: The battery needs to be at a certain temperature to provide optimal performance. However, when the battery is fully charged and the vehicle is in idle or in sleep mode, the battery temperature drops. Also, based on climatic conditions during the operation of the vehicle the battery may not reach the temperature level required for optimal performance. Pre-heating the battery is required in such situations to achieve optimal performance.

Business solution 2: Battery gets heated while discharging. Identifying monetary opportunities associated with heating the battery by discharging provides a monetary gain.

Technical solution 2: In one aspect, the present disclosure discloses a system monitoring the health and performance of the vehicle battery to determine a temperature that will provide peak performance, i.e., the peak performance temperature. The system identifies one or more schemes to heat the vehicle battery to achieve the optimum performance based on the temperature of the vehicle battery being below the peak performance temperature. One scheme is to identify discharging opportunities based on a travel schedule (e.g., if the system knows that the driver has planned to travel from A to B, the system identifies a stopover location to stop and discharge the battery). The system identifies a charging station that provides the highest monetary return for discharging while heating the battery to the peak performance temperature. In some embodiments, the system identifies a charging station that quotes the least price for charging the vehicle battery. The system maximizes the monetary gain by charging while heating the battery to the peak performance temperature.

In an aspect, the present disclosure relates to a system comprising a battery monitoring unit; and a processor communicatively coupled to the battery monitoring unit, wherein the processor is operable to: receive, from the battery monitoring unit, a temperature associated with a vehicle battery; determine whether the temperature is below a peak performance temperature; determine a monetization opportunity associated with increasing the temperature of the vehicle battery based on the temperature being below the peak performance temperature; identify a scheme to increase the temperature of the vehicle battery based on the monetization opportunity; and execute the scheme to maximize a monetary gain.

In another aspect, the present disclosure relates to a method comprising: receiving, by a processor, a temperature associated with a vehicle battery; determining, by the processor, whether the temperature is below a peak performance temperature; determining, by the processor, a monetization opportunity associated with increasing the temperature of the vehicle battery based on the temperature being below the peak performance temperature; identifying, by the processor, a scheme to increase the temperature of the vehicle battery based on the monetization opportunity; and executing the scheme to maximize a monetary gain.

In yet another aspect, the present disclosure relates to a non-transitory computer-readable medium having stored thereon instructions executable by a processor to perform operations comprising: receiving a temperature associated with a vehicle battery; determining whether the temperature is below a peak performance temperature; determining a monetization opportunity associated with increasing the temperature of the vehicle battery based on the temperature being below the peak performance temperature; identifying a scheme to increase the temperature of the vehicle battery based on the monetization opportunity; and executing the scheme to maximize a monetary gain.

Technical Result2: Selecting a charging station and determining a pre-heating scheme associated with the charging station that provides the maximum monetary value, thus, enabling the user associated with the vehicle to maximize a monetary gain.

Technical Details Specific to the Technical Solution2: Referring to FIG. 1, while the vehicle is traveling from source 102 to destination 106, the vehicle system or the system associated with the vehicle may identify that the battery temperature has fallen below the peak performance temperature. The travel route may comprise one or more stopover locations 104 comprising one or more charging stations or energy sources. Upon determining that the battery temperature of the vehicle has fallen below the peak performance temperature, the system determines whether there are any monetization opportunities around the stopover location associated with heating the battery. The system further identifies a scheme to increase the temperature of the battery based on the monetization opportunity. In some embodiments, the scheme comprises increasing the temperature of the battery by discharging, if the pricing per unit of charge is above a first predefined value. The system enables connecting to the charging station providing the maximum monetary value and executing the scheme, for example, discharging the vehicle battery to maximize the monetary gain. In some embodiments, the scheme comprises increasing the temperature of the battery by charging if the pricing per unit of charge is below a second predefined value.

In some embodiments, the system may determine a charge level associated with the vehicle battery and increase the temperature of the vehicle battery by discharging the vehicle battery based on the charge level being above a threshold charge level. In some embodiments, the system may determine to increase the temperature of the vehicle battery by charging the vehicle battery based on the charge level being below the threshold charge level.

In some embodiment, the system communicates with a charging station at a first stopover location in a geographical area to determine the presence of monetization opportunities associated with heating the battery. If there is no monetization opportunity at the charging station at the first location, the system scans for other charging stations at a second location in the geographical area. If the system identifies better monetization opportunities at the second location, the system may send an alert signal or an indication to the driver to stop at the second location.

In some embodiments, the system determines a time period associated with increasing the temperature of the vehicle battery to the peak performance temperature; and connects to the at least one energy source associated with the stopover location based on the time period. For example, if the system determines that the time to increase the battery temperature will be around 2 hours, the system may indicate/suggest the driver to stop at a shopping center or a hotel instead of stopping over at a coffee shop.

In some embodiments, the system transmits an alert message to the user of the vehicle upon the battery heated to the peak performance temperature. In some embodiments, the user of the vehicle may acknowledge the message to stop heating or may suggest continuing heating for an additional time. For example, if the user wants to stay at the location and is not ready to leave, the user can request the system to continue with the heating scheme. The system alters the charging/discharging scheme based on the user's response to the alert message.

How Technical Solution 2 is a Technological Advancement: The present disclosure discusses techniques for getting monetary benefits associated with heating the battery. The technique enables the vehicle to work at the optimal level and at the same time fetches monetary gain to the user of the vehicle.

It would be appreciated by a person ordinarily skilled in the art that network 100 is not restricted to only the components shown in FIG. 1 and may include various other components. Further, the system may be any system associated with the vehicle. In some embodiments, the system may be placed within the vehicle. In some embodiments, the system may be a centralized system controlling the discharging of one or more vehicle batteries based on the monetization opportunity.

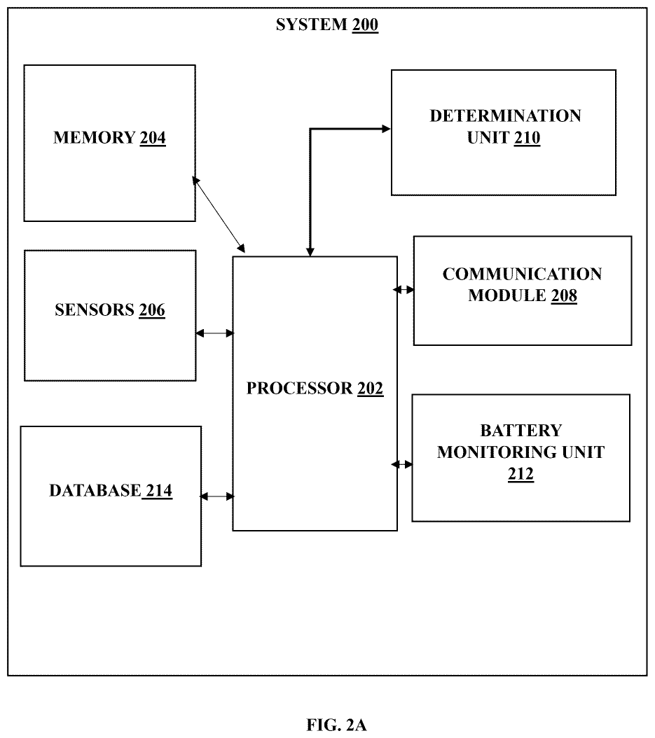

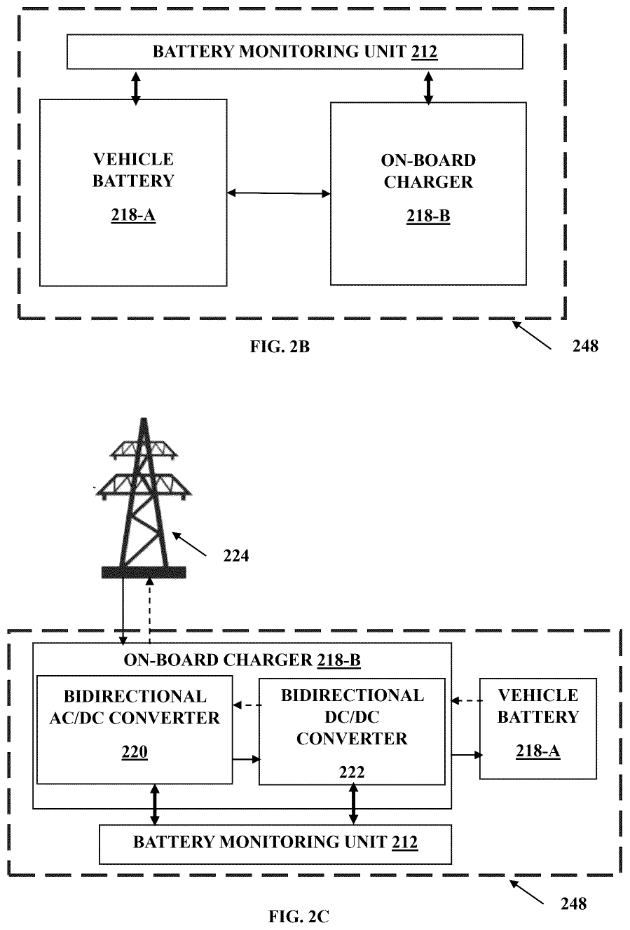

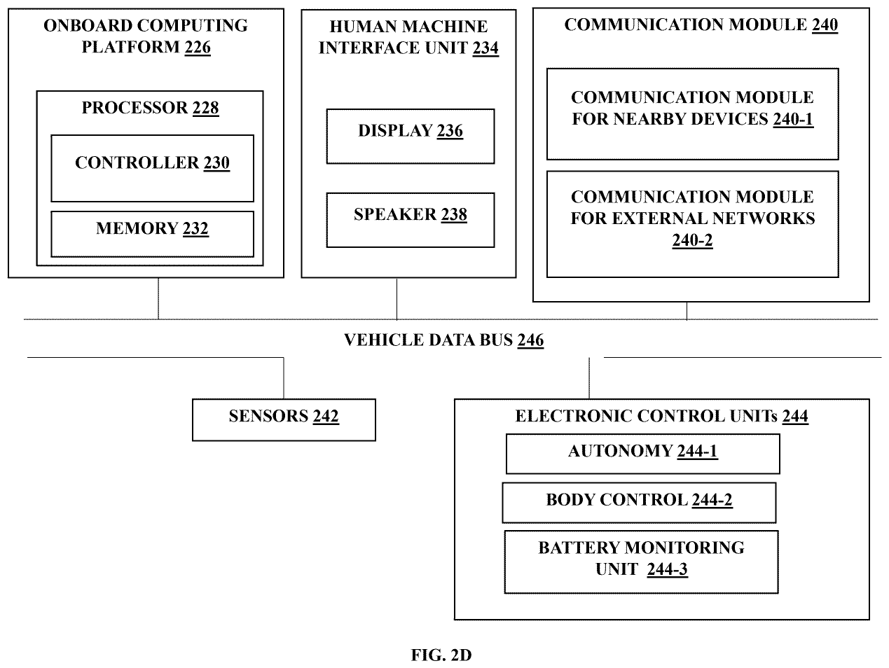

FIG. 2a Illustrates a Block Diagram of a System Associated With a Vehicle According to an embodiment.

In some embodiments, the system associated with the vehicle determines a monetization opportunity associated with heating the vehicle battery to an optimal temperature. In some embodiments, the system associated with the vehicle performs discharging based on a monetization opportunity. In some embodiments, the system enables communication with an energy source to identify discharge opportunities.

System 200 comprises processor 202, memory 204, sensors 206, communication module 208, determination unit 210, battery monitoring unit 212, database 214, and alert generation module 216.

Referring to FIG. 2A, processor 202 may be a high-performance, multi-core CPU or system-on-chip (SoC) solution to process vast amounts of data. In some embodiments, processor 202 processes data from battery monitoring unit 212 and determination unit 210 and other inputs to make real-time decisions related to communicating with the energy source, for example, the charging station, for identifying monetary opportunities associated with discharging the vehicle battery. In some embodiments, processor 202 processes a charge level data from battery monitoring unit 212 and a comparison data associated with comparing the charge level data with a threshold charge level from the determination unit to determine monetary opportunities associated with discharging. In some embodiments, processor 202 processes a battery temperature data from the battery monitoring unit 212 and a comparison data associated with comparing the battery temperature data with a peak performance temperature to determine monetary opportunities associated with heating the vehicle battery. Processor 202 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors'function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 202 interacts and exchanges data with one or more of the other components or modules of the system, for example, memory 204, sensors 206, communication module 208, determination unit 210, battery monitoring unit 212, database 214, and alert generation module 216.

In some embodiments, the vehicle comprises battery unit. Battery unit 248 comprising battery monitoring unit 212 operatively coupled to a vehicle battery and an on-board charger is illustrated in FIG. 2B. In an embodiment, the battery monitoring unit is operable to control the operation of the on-board charger for charging and discharging the vehicle battery.

Referring to FIG. 2A, memory 204 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 2A, sensors 206 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, including cameras, LIDARs, radars, and ultrasonic sensors enable autonomous vehicles to detect and recognize objects, obstacles, and pedestrians on the road to enable navigation of the autonomous vehicles. In some embodiments, communication module 208 facilitates communication between different modules within system 200, communication between the vehicle and other devices, other vehicles, and other infrastructure components or energy source, for example, grid, charging station, etc.

Referring to FIG. 2A, in some embodiments, database 214 may store data associated with various sensors 206, determination unit 210, and battery monitoring unit 212. In some embodiments, database 214 may be locally present in system 200 or may be present in a server associated with a manufacturer of the vehicle or in a cloud server. Processor 202 may fetch the data from the database to determine a charge level and temperature level and establish a communication with one or more energy sources or charging stations to identify monetary opportunities associated with battery discharging or battery heating. Further, database 214 may also store a first predefined value and a second predefined value associated with maximizing monetary gain by discharging and charging, respectively.

Referring to FIG. 2A, communication module 208, determination unit 210, and battery monitoring unit 212 are coupled to processor 202. Communication module 208 is operable to communicate with external devices such as energy source/charging station and receive information related to monetary benefits provided by the energy source in exchange for stored charge. In some embodiments, communication module 208 establishes communication with one or more charging stations at a geographical location and receives from the one or more charging stations, a monetary value associated with at least one of charging a vehicle battery and discharging the vehicle battery. In some embodiments, the communication module obtains, from the one or more charging stations, a first message associated with opportunities for charging and discharging a vehicle battery with the one or more charging stations. In some embodiments, the communication module transmits a second message comprising at least one of the one or more parameters associated with the vehicle battery, a first predefined value, and a second predefined value to the one or more charging stations; and receives a third message from the one or more charging stations, wherein the third message provides an availability of a monetization opportunity at the one or more charging stations based on the second message.

In some embodiments, determination unit 210 is communicatively coupled to processor 202. Processor 202 is operable to receive, through the communication module, a first message associated with opportunities for charging and discharging a vehicle battery with the one or more charging stations and receive from the determination unit one or more parameters associated with the vehicle battery. The processor is operable to select a charging station from the one or more charging stations based on the first message and the one or more parameters and schedule a connection with the charging station to perform at least one of charging and discharging the vehicle battery to maximize a monetary gain.

In some embodiments, the first message comprises at least one of: a number of chargers associated with the one or more charging stations, number of vehicles connected to the one or more charging stations, amount of charge required at the one or more charging stations, amount of charge required by one or more grids associated with the one or more charging stations, a monetization opportunity, and a duration of the monetization opportunity.

In some embodiments, processor 202 is operable to receive through the communication module a monetary value associated with at least one of charging a vehicle battery and discharging the vehicle battery from one or more charging stations at a geographical location, to select at least one charging station of the one or more charging stations at the geographical location based on the monetary value, and to perform at least one of charging the vehicle battery and discharging the vehicle battery with the at least one charging station to maximize a monetary gain.

In some embodiments, the processor is operable to determine whether the monetary value is more than a first predefined value; determine a first charging station of the one or more charging stations providing the monetary value more than the first predefined value; and connect to the first charging station and discharge the vehicle battery.

In some embodiments, the processor is operable to monitor an increase in the monetary value based on the monetary value being less than the first predefined value; and discharge the vehicle battery based on the increased monetary value being more than the first predefined value, wherein the first predefined value is associated with maximizing the monetary gain based on discharging the vehicle battery.

In some embodiments, the processor is operable to determine whether the monetary value is less than a second predefined value; determine a second charging station of the one or more charging stations providing the monetary value less than the second predefined value; and connect to the second charging station and charge the vehicle battery. In an embodiment, the processor enables charging the vehicle battery to a 100 percent charge level based on the monetary value being less than the second predefined value, wherein the second predefined value is associated with maximizing the monetary gain based on charging the vehicle battery.

In some embodiments, processor 202 is further operable to transmit a control signal to the battery monitoring unit in the vehicle to perform at least one of charging the vehicle battery or discharging the vehicle battery based on the monetary value.

In some embodiments, processor 202 is operable to receive, from the battery monitoring unit, a temperature associated with the vehicle battery, determine whether the temperature is below a peak performance temperature, determine a monetization opportunity associated with increasing the temperature of the vehicle battery based on the temperature being below the peak performance temperature, identify a scheme to increase the temperature of the vehicle battery based on the monetization opportunity, and execute the scheme to maximize a monetary gain.

In some embodiments, processor 202 is further operable to transmit a control signal to the battery monitoring unit in the vehicle to execute the scheme to heat the battery to maximize the monetary gain.

In some embodiments, the scheme comprises at least one of: increasing the temperature of the vehicle battery by charging the vehicle battery and increasing the temperature of the vehicle battery by discharging the vehicle battery. In some embodiments, the processor transmits the control signal i.e., the processor communicates to the battery monitoring unit to increase the temperature of the vehicle battery by discharging the vehicle battery based on the pricing associated with discharging the vehicle battery is above a first predefined value. In an embodiment, the processor is operable to determine a charge level associated with the vehicle battery; and increase the temperature of the vehicle battery by discharging the vehicle battery based on the charge level being above a threshold charge level, wherein the threshold charge level is determined based on at least one of a minimum charge level required by a vehicle to reach its destination, environmental conditions associated with a travel route of the vehicle, and efficiency of the vehicle battery.

In some embodiments, the processor transmits the control signal to increase the temperature of the vehicle battery by charging the vehicle battery based on the charge level being below the threshold charge level. In an embodiment, the processor transmits the control signal to increase the temperature of the vehicle battery by charging the vehicle battery based on the pricing associated with charging the vehicle battery being below a second predefined value.

In one embodiment, processor 202 is further coupled with alert generation module 216. The alert generation module is configured to generate an alert signal based on the battery temperature reaching its peak performance temperature. Processor 202 indicates, based on the alert signal, to a user of the vehicle that the temperature of the vehicle battery is equal to the peak performance temperature. Further, the processor is operable to receive a response from the user based on the alert signal and alter the scheme based on the response. The processor is further operable to perform at least one of continuing with the execution of the scheme; and stopping the execution of the scheme, based on the response. In some embodiments, the user may acknowledge the alert signal and provide a response to stop heating the battery. In some embodiments, the user may like to extend his stay at the stopover location and may prefer to continue heating the battery.

It would be appreciated by a person ordinarily skilled in the art that system 200 is not limited to the components mentioned and may include more components based on the functional needs of the system. Further, the modules mentioned in the system may be software based, hardware based, or a combination of hardware and software. The modules may be communicatively and operatively coupled to one another and with processor 202.

FIG. 2B shows a block diagram of a battery unit in a vehicle according to an embodiment.

Referring to FIG. 2B, battery unit 248 comprising battery monitoring unit 212 operatively coupled with vehicle battery 218-A and on-board charger or on-board vehicle charger 218-B is shown. In some embodiments, the vehicle battery is coupled to the on-board vehicle charger. Battery monitoring unit 212 may perform one or more control and monitoring operations associated with vehicle battery 218-A and on-board charger 218-B. In some embodiments, vehicle battery 218-A includes a plurality of battery modules comprising one or more battery cells. Battery monitoring unit 212 may regulate the amount of electrical energy stored and discharged by the plurality of battery modules, perform load balancing in the one or more battery cells, control charging and discharging of the one or more battery cells, determine a charge level associated with the plurality of battery modules, determine a temperature level associated with the vehicle battery, and determine a charge level available for discharging from the battery modules.

Referring to FIG. 2B, on-board charger 218-B enables charging and discharging the vehicle battery 218-A when the vehicle is plugged in. In an embodiment, the on-board charger comprises a bidirectional charger, wherein the bidirectional charger provides charging of the vehicle battery from the energy source and discharging from the vehicle battery to the energy source.

Referring to FIG. 2B, in some embodiments, processor 202 of FIG. 2A transmits a control signal to battery monitoring unit 212 thereby enabling the battery monitoring unit to control the operation of the on-board charger to perform at least one of charging the vehicle battery or discharging from the vehicle battery. For example, the processor may command the communication module to establish communication with one or more charging stations at a geographical location and obtain, from the one or more charging stations, a first message associated with opportunities for charging and discharging a vehicle battery with the one or more charging stations. The first message may comprise a monetary value associated with at least one of charging a vehicle battery and discharging the vehicle battery. In some embodiments, the processor may command the battery monitoring unit to control at least one of charging the vehicle battery and discharging the vehicle battery with at least one charging station to maximize a monetary gain. For example, in some embodiments, the processor may command the communication module to establish communication with one or more energy source at a geographical location and obtain, from the one or more energy sources, a message associated with opportunities for heating a vehicle battery Further, the processor may command the battery monitoring unit to heat the vehicle battery by at least one of charging the vehicle battery and discharging the vehicle battery with at least one energy source to maximize a monetary gain.

FIG. 2C illustrates a functional block diagram of an on-board charger in the battery unit according to an embodiment.

Referring to FIG. 2C, on-board charger 218-B comprises bi-direction alternating current (AC) to direct current (DC) converter 220 and bi-directional DC-DC converter 222. The two bidirectional converters enable both grid to vehicle (G2V) or energy source to vehicle communication, and vehicle to anything (V2X) communication. In some embodiments, the operation of on-board charger 218-B is controlled by one or more control signals from the battery monitoring unit. In an embodiment, battery monitoring unit 212 provides a control signal to enable G2V communication. The power from grid 224 is converted from AC to DC using bi-directional AC-DC converter 220, wherein the converted DC is stepped down using bi-directional DC-DC converter 222 for charging the vehicle battery. In another embodiment, battery monitoring unit 212 provides a control signal to enable V2X communication or discharge charge from the vehicle to the grid or energy source. The charge from the vehicle battery is up converted using bi-directional DC-DC converter 222, wherein the up converted DC signal is converted to AC using bi-directional AC-DC converter 220. In some embodiments, the processor sends control signals to the battery monitoring unit to control both the charging (e.g., G2V communication) and the discharging (e.g., V2X communication) operations, wherein the control signals are sent based on the determining of a maximized monetary gain.

FIG. 2D illustrates a block diagram of various electronic components of the vehicle according to an embodiment.

Referring to FIG. 2D, the vehicle comprising various electronic components, such as, onboard computing platform 226, human-machine interface (HMI) unit 234, communication module 240, sensors 242, electronic control units (ECUs) 244, and vehicle data bus 246, is shown. FIG. 2D illustrates an example architecture of some of the electronic components, as shown in FIG. 2A. Onboard computing platform 226 comprises processor 228 (also referred to as a microcontroller unit or a controller) and memory 232. In the illustrated example, processor 228 of the onboard computing platform is structured to comprise controller 230. In other examples, controller 230 is incorporated into another ECU with its own processor and memory. The processor may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 232 comprises multiple kinds of memory, particularly volatile memory, and non-volatile memory. Memory 232 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 232, the computer-readable medium, and/or within processor 228 during execution of the instructions.

HMI unit 234 provides an interface between the vehicle and a user. HMI unit 234 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 236 (e.g., a heads-up display, a center console display such as a liquid crystal display (LCD), an organic light emitting diode (OLED) display, a flat panel display, a solid state display, etc.), and/or speaker 238. For example, the display, the speaker, and/or other input and output device(s) of HMI unit 234 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 236.

Sensors 242 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 242 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

Referring to FIG. 2D, ECUs 244 monitor and control the subsystems of the vehicle. For example, ECUs 244 are discrete sets of electronics that comprise their own circuit(s) (e.g., integrated circuits, microprocessors, memory, storage, etc.) and firmware, sensors, actuators, and/or mounting hardware. ECUs 244 communicates and exchanges information via vehicle data bus 246. Additionally, the ECUs may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus.

In the illustrated example, ECUs 244 comprise autonomy unit 244-1, body control module 244-2, and battery monitoring unit 244-3. For example, autonomy unit 244-1 is operable to perform autonomous and/or semi-autonomous driving maneuvers (e.g., defensive driving maneuvers) of the vehicle based upon, at least in part, instructions received from controller 230 and/or data collected by sensors 242 (e.g., object detection sensors). Further, body control module 244-2 controls one or more subsystems throughout the vehicle, such as power windows, power locks, an immobilizer system, power mirrors, etc. For example, body control module 244-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, battery monitoring unit 244-3 (similar to battery monitoring unit 212 of FIG. 2A) is operable to control the bi-directional on-board charger for charging and discharging the vehicle battery based on controls signal from the processor. The processor provides the control signals based on whether charging the vehicle battery or discharging the vehicle battery provides a maximum monetary benefit.

Referring to FIG. 2D, vehicle data bus 246 communicatively couples communication module 240, onboard computing platform 226, HMI unit 234, sensors 242, and ECUs 244. In some examples, vehicle data bus 246 comprises one or more data buses. Vehicle data bus 246 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 2D, communication module 240 may comprise a near field communication module or a communication module for nearby device 240-1 and far field communication module or communication module for external network 240-2. Communication module for nearby devices 240-1 is operable to communicate with other nearby communication devices. In an example, communication module 240 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 240-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, communication module 240-2 is operable to communicate with external networks. For example, communication module 240-2 comprises hardware (e.g., processors, memory, storage, antenna, etc.) and software to control wired or wireless network interfaces. In the illustrated example, the communication module 240-2 comprises one or more communication controllers for wireless networks, satellite communication network, microwave communication network, fiber optic communication network, cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 240-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 244-1 of the illustrated example is operable to perform autonomous and/or semi-autonomous driving maneuvers, such as defensive driving maneuvers, for the vehicle. For example, autonomy unit 244-1 performs the autonomous and/or semi-autonomous driving maneuvers based on data collected by sensors 242. In some examples, autonomy unit 244-1 is operable to operate a fully autonomous system, a park-assist system, an advanced driver-assistance system (ADAS), and/or other autonomous system(s) for the vehicle.

Further, in the illustrated example, controller (or control module) 230 is operable to monitor an ambient environment of the vehicle. For example, to enable autonomy unit 244-1 to perform autonomous and/or semi-autonomous driving maneuvers, the controller collects data that is collected by sensors 242 of the vehicle. In some examples, the controller collects location-based data via communication module 240-1 and/or another module (e.g., a GPS receiver) to facilitate the autonomy unit in performing autonomous and/or semi-autonomous driving maneuvers. Additionally, the controller collects data from (i) adjacent vehicle(s) via communication module 240-1 and V2V communication and/or (ii) roadside unit(s) via communication module 240-1 and V2I communication to further facilitate autonomy unit 244-1 in performing autonomous and/or semi-autonomous driving maneuvers.

According to an embodiment, the communication module supports a communication protocol, wherein the communication protocol comprises at least one of an Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

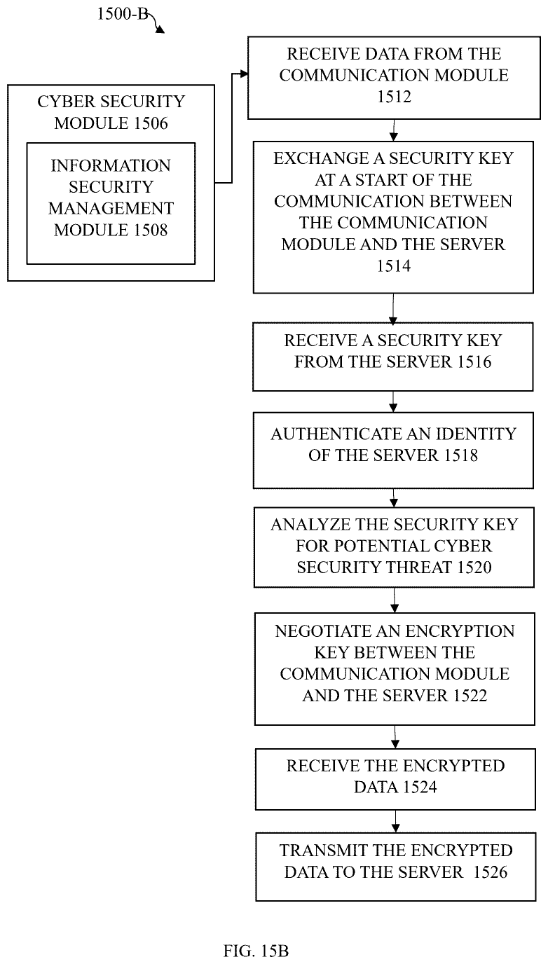

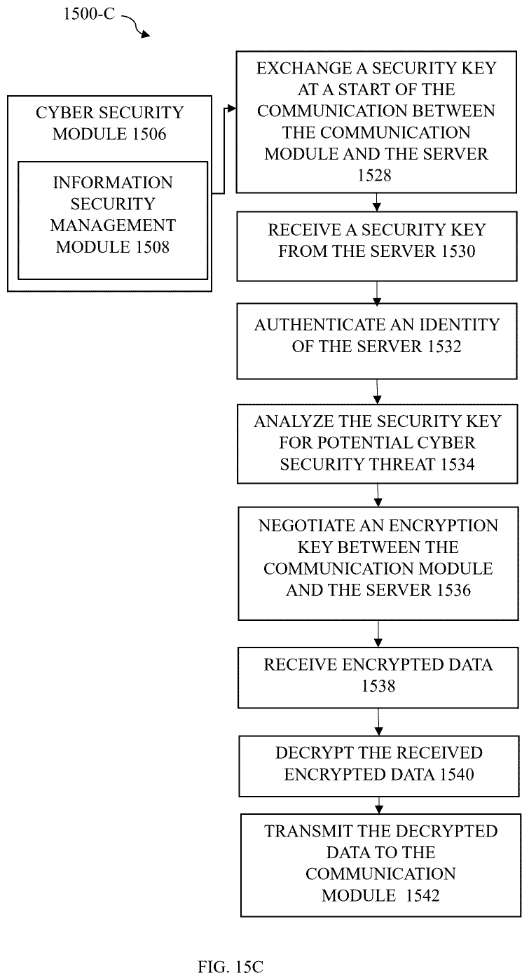

In an embodiment, communication module 240 may comprise a cyber security module 1506 (shown in FIG. 15A). In some embodiments, communication module 240 may communicate with cyber security module 1506 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

Business problem 3: To obtain monetary gain by either giving away excessively stored charge in a vehicle battery back to the energy source/grid or by heating the battery, a proper communication between the vehicle system and the energy source/charging station/grid is needed.

Technical problem 3: An effective communication between the vehicle system and the charging station is required to maximize a monetary gain associated with discharging or with heating the battery,

Business solution 3: Defining a set of parameters that are to be communicated between the vehicle system and the charging station enables effective communication to achieve maximum monetary gain.

Technical solution 3: In an aspect, the present disclosure discusses a system operable to establish communication with a charging station and receive information from the charging station. The information may include such as, not limited to, number of charges plugged in for charging, charging requirement from the charging station, charging requirement from the grid connected to the charging station, a monetary value, and a duration of the monetary value. Based on the information received, the system may determine if the monetary value is above a first predefined value. If monetary value is above the first predefined value, the system schedules a slot at the charging station. On the other hand, if the monetary value is below the first predefined value, the system can provide an alternate solution. In some embodiments, the alternate solution may include the system scanning for other charging stations providing a higher monetary value and scheduling a connection with the charging station providing a higher monetary value. In some embodiments, the alternate solution may include the system determining whether a price for charging the vehicle battery is less than a second predefined value. The system may then charge the battery to full capacity to enable a battery discharge at a later time (e.g., when the monetary value for discharge increases) to maximize profit. In an embodiment, the system may use the HMI in the vehicle system or a mobile device associated with the vehicle to display alternate options to the user/driver. In another aspect, the present disclosure discusses the vehicle system transmitting one or more data values to the charging station, and the charging station may determine if the desired monetization value may be achieved based on information available to the charging station. The charging station may negotiate the pricing scheme with the vehicle system.

Technical Result 3: Communication of proper parameters between the vehicle system and the charging station enables achieving a maximized monetary gain by the user.

Technical Details Specific to the Technical Solution 3: In some embodiments, communication module 240 may receive information associated with pricing provided by the energy source or the charging station for discharging the vehicle battery and pricing per unit of charge quoted for charging the vehicle battery. Communication module 240 may communicate the received information to the processor to determine whether to charge or discharge the vehicle battery to maximize the monetary gain for the user of the vehicle. In some embodiments, battery monitoring unit 244-3 may determine that the temperature of the vehicle battery is below the peak performance temperature and may communicate the same to processor 228. The processor may then transmit a control signal to the communication module to establish communication with one or more energy sources/charging stations in the geographical area to determine a monetary value associated with pre-heating the battery.

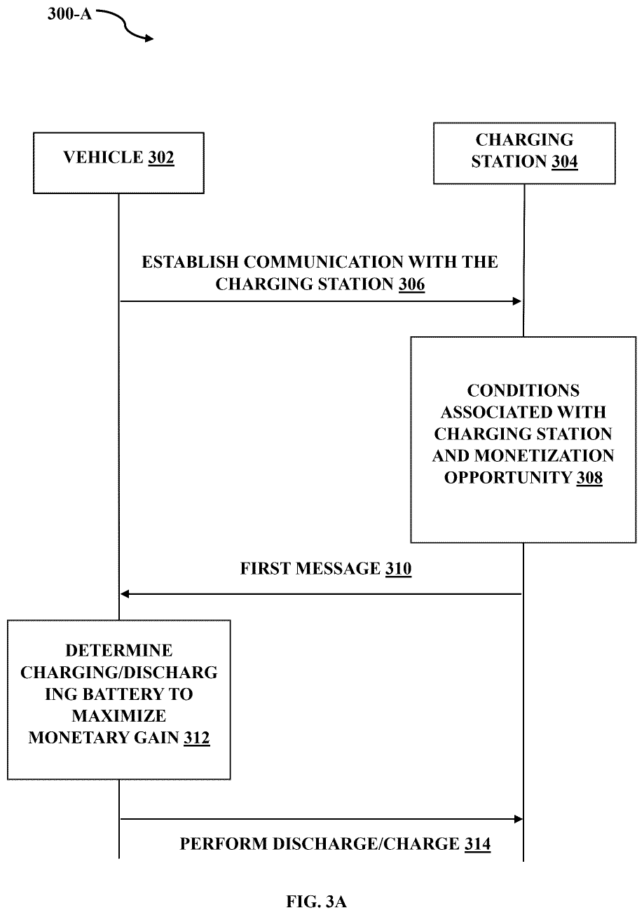

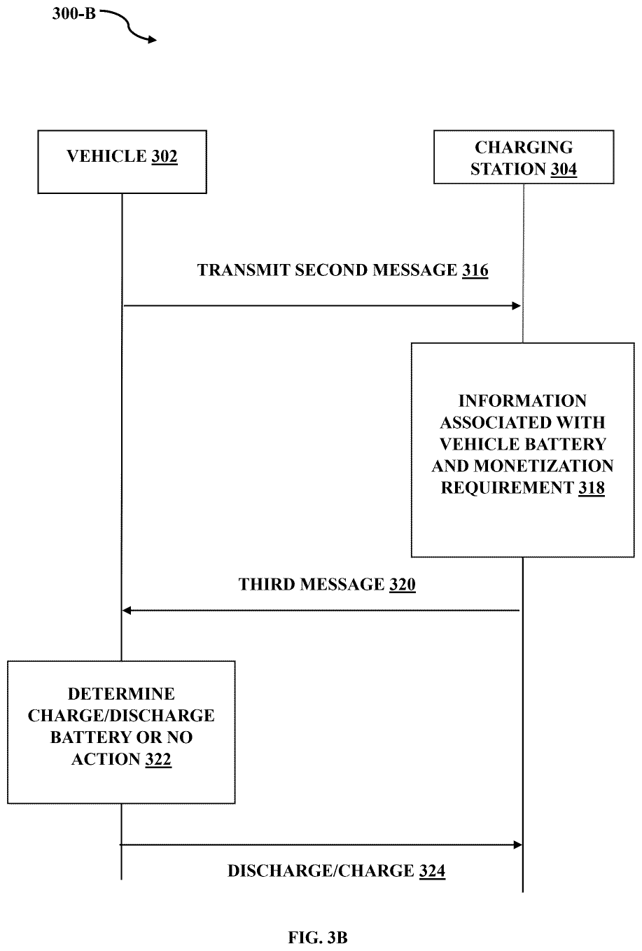

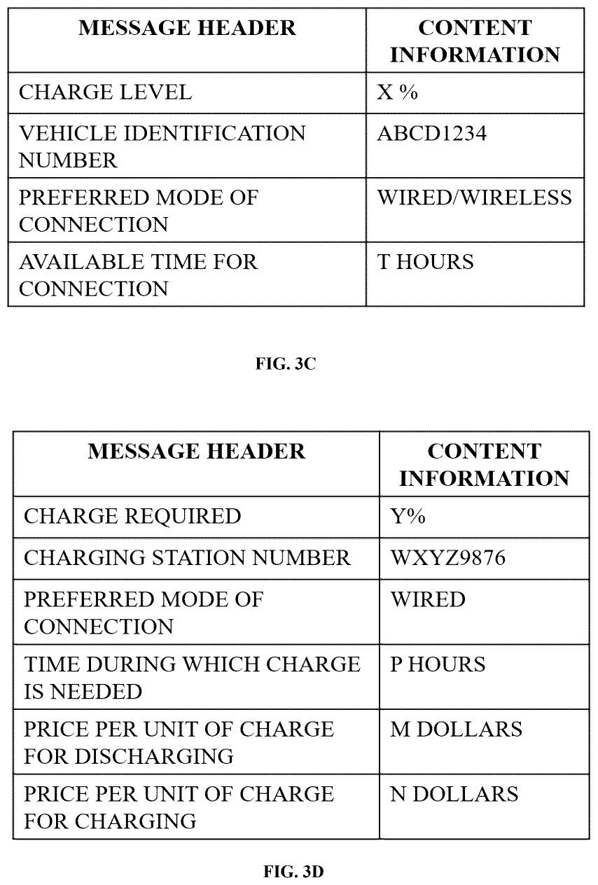

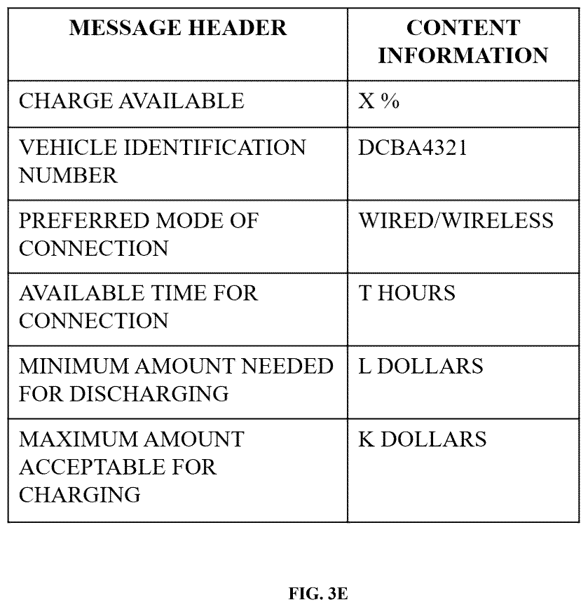

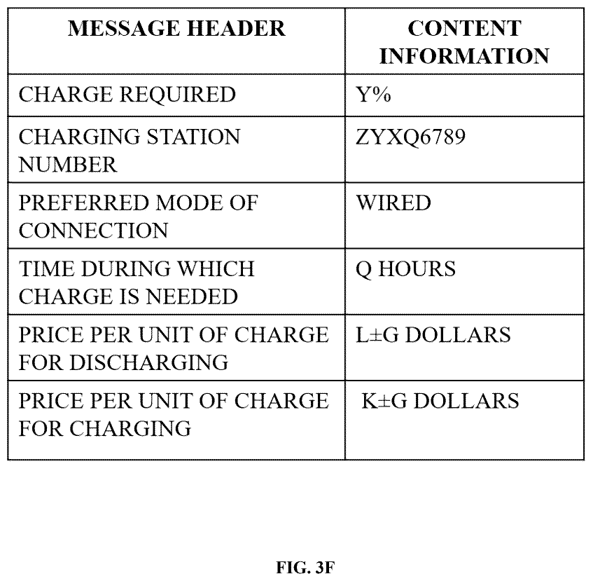

FIG. 3A illustrates message flow diagram 300-A between the vehicle and a charging station according to an embodiment.

Referring to FIG. 3A, vehicle 302 in communication with an energy source or charging station 304 is shown. In an embodiment, charging station 304 may be associated with a grid. In some embodiments, the grid comprises at least one of a power grid, a smart grid, and a micro grid. In some embodiments, the charging station may be a vehicle charging station at a stopover location in a travel route of the vehicle. In some embodiments, vehicle 302 may communicate with one or more charging stations in a geographical location. In some embodiments, the geographical location comprises a stopover location in the travel route of the vehicle, wherein the stopover location comprises a location where the vehicle is in a stationary state or a parked condition. In some embodiments, the stopover location comprises at least one of a resting place, a dining place, a parking place, a shopping area, a medical center, and a workshop.

In some embodiments, vehicle 302 may determine a charge level associated with the vehicle battery and establish communication at step 306 with the one or more charging stations based on the charge level above a threshold charge level. The threshold charge level is determined based on at least one of a travel route of a vehicle, environmental conditions affecting the vehicle, and efficiency of the vehicle battery, wherein the environmental conditions affecting the vehicle comprises at least one of a weather condition and a physical condition associated with the travel route. In some embodiments, the efficiency of the vehicle battery is based on at least one of charge and discharge current, state of charge, temperature of the vehicle battery, an internal resistance value, and age of the vehicle battery.

In some embodiments, charging station 304 determines at step 308 one or more conditions associated with the charging station and a monetization opportunity based on the one or more conditions. In some embodiments, the one or more conditions comprise a number of chargers associated with the charging station, number of vehicles connected to the charging station, amount of charge required at the charging station, amount of charge required by one or more grids associated with the charging station, etc. Charging station 304 transmits a first message 310 to the vehicle, wherein the first message comprises at least one of: a number of chargers associated with the charging station, number of vehicles connected to the charging station, amount of charge required at the charging station, amount of charge required by one or more grids associated with the charging station, a monetization opportunity, and a duration of the monetization opportunity.

In some embodiments, the monetization opportunity comprises a price per unit of charge provided by the charging station. In an embodiment, the price comprises a first price per unit of charge provided by the charging station for discharging the vehicle battery. In another embodiment, the price comprises a second price per unit of charge provided by the charging station for charging the vehicle battery.

In an embodiment, the duration of the monetization opportunity comprises the first price per unit of charge provided by the charging station for a first time period. In another embodiment, the duration of the monetization opportunity comprises the second price per unit of charge provided by the charging station for a second time period. For example, during a peak time there may be more load connected to the charging station and the charging station may have a higher charge requirement. During such times, the price per unit of charge provided to get energy from the external source (i.e., the vehicle battery) may be very high (more than the first predefined value). In such situations, the user gets maximum monetary gain by discharging the vehicle battery. On the other hand, during a valley time (i.e, a non-peak time) there may be a few loads connected to the charging station and the charging station may have a higher amount of stored charge. During such times, the price per unit of charge quoted for giving away the energy (i.e, charging the vehicle battery) may be very less (less than the second predefined value). In such situations, the user gets maximum monetary gain by discharging the vehicle battery.

In some embodiments, during the peak time, i.e., the time when the price per unit of charge provided to get energy from the external source (i.e., the vehicle battery) is high (more than the first predefined value, the vehicle may heat the battery by increasing the temperature of the battery by discharging. On the other hand, during the valley time, i.e., the time when the price per unit of charge quoted for giving away the energy (i.e, charging the vehicle battery) may be very less (less than the second predefined value), the vehicle may heat the battery by increasing the temperature of the battery by charging.

Referring to FIG. 3A, vehicle 302 upon receiving the first message from charging station 304, determines at step 312 whether charging or discharging the vehicle battery will fetch a maximum monetary gain. Based on the determination, vehicle 302 may connect with the charging station to perform at step 314 at least one of charging or discharging.

In some embodiments, the vehicle compares the first price per unit of charge with a first predefined value, determines whether the first price per unit of charge is more than the first predefined value, and connects to the charging station and discharges the vehicle battery if the first price per unit of charge is more than the first predefined value. On the other hand, if the first price per unit of charge is less than the first predefined value, the vehicle compares the second price per unit of charge with a second predefined value. If the second price per unit of charge is less than the second predefined value, the vehicle connects to the charging station and charges the vehicle battery to a maximum capacity. In some embodiments, the vehicle may monitor an increase in the first price per unit of charge, based on the first price per unit of charge being less than the first predefined value, and connect to the charging station to discharge the vehicle battery when the first price per unit of charge increases more than the first predefined value.

In some embodiments, vehicle 302 may establish communication with one or more charging stations at the geographical location, and obtain, from the one or more charging stations, a first message associated with opportunities for charging and discharging a vehicle battery with the one or more charging stations, determine one or more parameters associated with the vehicle battery, and select a charging station from the one or more charging stations based on the first message and the one or more parameters, and schedule a connection with the charging station to perform at least one of charging and discharging the vehicle battery to maximize monetary gain.

In some embodiments, the one or more parameters associated with the vehicle battery comprises at least one of a charge level of the vehicle battery and a temperature level of the vehicle battery.

FIG. 3B illustrates message flow diagram 300-B between the vehicle and the charging station according to another embodiment.

Referring to FIG. 3B, vehicle 302 transmits at step 316 a second message to the charging station. The second message comprises at least one of the one or more parameters associated with the vehicle battery, the first predefined value, and the second predefined value. In some embodiments, the one or more parameters comprises at least one of a charge level of the vehicle battery and a temperature level of the vehicle battery.

In some embodiments, the first predefined value specifies a minimum pricing per unit of charge accepted by the vehicle user for discharging the vehicle battery, i.e., if the first price per unit of charge or the monetary value provided by the charging station for discharging is less than the first predefined value, the vehicle determines not to discharge and checks for charging opportunity. In some embodiments, the second predefined value specifies the maximum pricing per unit of charge accepted by the vehicle user for charging the vehicle battery, i.e., if the second price per unit of charge or the monetary value provided by the charging station for charging is less than the second predefined value the vehicle determines to charge the vehicle battery to its full capacity, i.e., 100 percent.

In some embodiments, the user of the vehicle may set the first and second predefined values. In some embodiments, the first and second predefined values may be determined based on a past history of monetary values for which charging and discharging the vehicle battery was performed.

Referring to FIG. 3B, charging station 304 determines at step 318 based on the received second message whether the charging station requires the charge level provided by the vehicle and can compensate the monetary requirement (first predefined value, second predefined value) mentioned in the second message. Charing station 304 may transmit a third message at step 320 to the vehicle wherein the third message provides an availability of a monetization opportunity at the one or more charging stations based on the second message. The vehicle may determine at step 322 whether to charge or discharge or take no action based on the monetization opportunity specified in the third message. For example, if the user has defined a minimum amount needed for discharging as O dollars and the charging station is able to provide only O−1 dollars, the vehicle may prefer to check for charging opportunities. If the user has defined a maximum amount acceptable for charging as K dollars and the charging station provides K−1 the vehicle charges the battery to its full capacity. On the other hand, if the charging station quotes K+1 dollars for charging, the vehicle may look for other charging stations providing a better monetary value. Based on the determination at step 322, the vehicle may at step 324 connect to the charging station to perform at least one of charging the vehicle battery or discharging the vehicle battery or look for other charging stations.

In some embodiments, the vehicle may determine the first and second predefined values based on the temperature level of the battery. Vehicle 302 may determine the battery temperature level is below the peak performance temperature and may determine a scheme to heat the battery to increase the temperature. The scheme includes either charging the battery to heat the battery or discharging the battery to heat the battery. Based on the time required for heating the battery, the vehicle can set the first and second predefined values. In some embodiments, the first and second predefined values are set based on maximizing the monetary gain associated with discharging and charging, respectively.

FIGS. 3C-3F illustrate message formats associated with various messages used for communicating monetization opportunities associated with charging and discharging the vehicle battery.

Referring to FIG. 3C, a format of a request message from the vehicle to the charging station according to an embodiment is shown. The request message may include one or more information related to the vehicle such as, not limited to, a charge level available for discharge from the vehicle, a vehicle identification number, preferred mode of connection with the charging station (e.g., wired charging or wireless charging), and the time at which the vehicle is available to connect with the charging station. In some embodiments, the vehicle determines a charge level associated with the battery and compares the charge level with a threshold charge level. The threshold level enables the vehicle to reach the destination and at the same time maximize monetary gain. In some embodiments, the threshold charge level is determined based on at least one of a travel route of a vehicle (e.g. current location of the vehicle, a distance to reach the destination, time taken to reach the destination), environmental conditions affecting the vehicle, and efficiency of the vehicle battery. The environmental conditions affecting the vehicle comprises at least one of a weather conditions and a physical condition associated with the travel route and the efficiency of the vehicle battery is based on at least one of charge and discharge current, state of charge, temperature of the vehicle battery, an internal resistance value, and age of the vehicle battery. In some embodiment, the vehicle may mention the time at which the vehicle will be able to connect with the charging station. The time available to connect may be determined based on a duration of the monetization opportunity or the time taken by the vehicle to reach the particular geographical location associated with the charging station.

In some embodiments, the duration of the monetization opportunity comprises a first time period during which the charging station provides the monetary value more than the first predefined value. In some embodiments, the duration of the monetization opportunity comprises a second time period during which the charging station provides the monetary value less than the second predefined value.

In some embodiments, the duration of the monetization opportunity comprises the first price per unit of charge provided by the one or more charging stations for a first time period. In some embodiments, wherein the duration of the monetization opportunity comprises the second price per unit of charge provided by the one or more charging stations for a second time period.

In some embodiments, the first time period comprises a peak time associated with a maximum charge requirement at the charging station and the second time period comprises a valley time associated with a maximum stored charge level present at the charging station.

FIG. 3D illustrates a format of a first message from the charging station to the vehicle according to an embodiment. In first message may include information related to the charging station such as, not limited to, amount of charge required at the charging station, charging station number (i.e., an identification number associated with the charging station), preferred mode of connection with the vehicle (e.g. wired or wireless), time during which the charge is needed, price per unit of charge provided for discharging the vehicle battery, and price per unit of charge provided for charging the vehicle battery.

FIG. 3E illustrates a format of a second message from the vehicle to the charging station according to an embodiment. The second message may include information related to charge available, vehicle identification number, preferred mode of connection, available time of connection, minimum amount needed for discharging, maximum amount acceptable for charging. The minimum amount and the maximum amount may be user defined, estimated based on previous charge and discharge cycles, or based on the temperature level or charge level associated with the vehicle battery.

FIG. 3F illustrates a format of a third message from the charging station to the vehicle according to an embodiment. The third message may include information related to amount of charge required at the charging station, charging station number (i.e. an identification number associated with the charging station), preferred mode of connection with the vehicle (e.g. wired or wireless), time during which the charge is needed, price per unit of charge provided for discharging the vehicle battery based on the price quoted in the second message, and price per unit of charge provided for charging the vehicle battery based on the price quoted in the second message.

In some embodiments, the vehicle may negotiate with the charging station based on the second and third messages to maximize the monetary gain.

How Technical Solution 3 is a Technological Advancement: Defining the communication parameters enables maximization of monetary gain for the user of the vehicle.

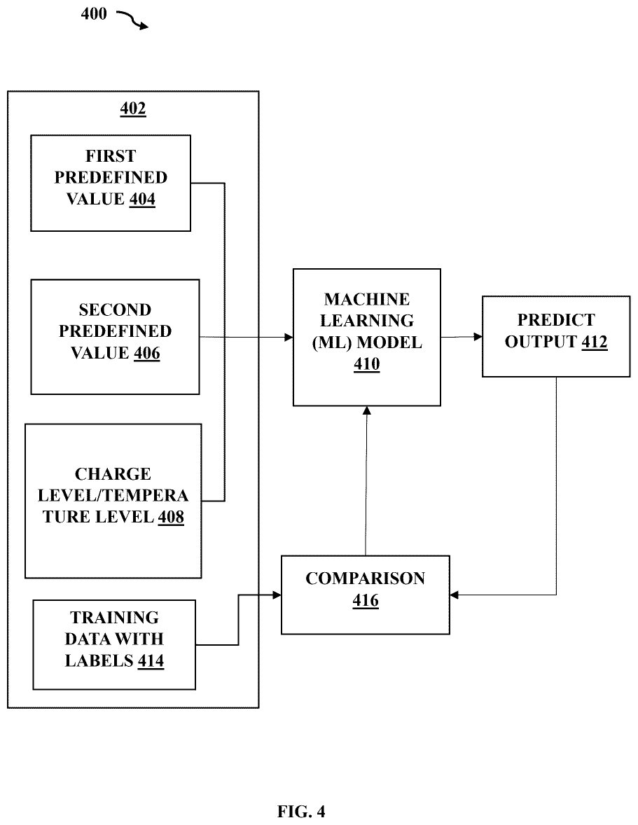

FIG. 4 illustrates an example block diagram 400 for an Artificial Intelligence and Machine Learning (AI/ML) model for maximizing a monetary gain.

Referring to FIG. 4, the machine learning model 402 may take as input any data associated with first predefined value 404, second predefined value 406, charge level associated with the vehicle battery 408 and learn to identify features within the data that are predictive of discharge the vehicle battery or charging the vehicle battery to maximize the monetary gain. In some embodiments, machine learning model 402 may take as input any data associated with first predefined value 404, second predefined value 406, temperature level associated with the vehicle battery 408 and learn to identify features within the data that are predictive of a scheme to heat the battery to the peak performance temperature to maximize the monetary gain associated with pre-heating the battery. Training data with labels 414 may comprise, for example, a historical data of monetary values provided by the charging stations for earlier charging and discharging cycles of the vehicle battery based on the time of the day, charge requirement at the charging station, number of chargers connected to the charging station, number of vehicles connected for discharging, heating duration, amount of charge obtained from the vehicle during the heating process, peak performance temperature of the vehicle battery, etc. In some embodiments, the training data, along with a current charge level of the vehicle, may be transmitted to the cloud for determining to perform either charging or discharging the battery to maximize the monetary gain. In some embodiments, the training data, along with a current temperature level of the vehicle battery, may be transmitted to the cloud for determining to select a scheme to heat the battery to maximize the monetary gain from heating the vehicle battery. The systems and methods of the present disclosure may also provide data analytics information that may be used later to improve the prediction accuracy of selecting the charging station providing the best monetary value and selecting the action (charging/discharging) or selecting a scheme to heat the battery to maximize the monetary gain.

In an embodiment, during training, machine learning model 410 may process the training data sample (e.g., first predefined value 404, second predefined value 406, charge level associated with the vehicle battery 408), and, based on the current parameters of machine learning model 410, predict output 412 which may be a selection of charging station and determining the action (charging or discharging) to be performed with the selected charging station to maximize the monetary gain. In an embodiment, machine learning model 410 may process the training data sample (e.g., first predefined value 404, second predefined value 406, temperature level associated with the vehicle battery 408), and, based on the current parameters of machine learning model 410, predict output 412 which may be a selection of charging station or an energy source and determining the scheme for heating the battery to be executed with the selected charging station or energy source to maximize the monetary gain. In an embodiment, the real-time sensor data may be processed using one or more machine learning models 410, trained based on similar types of data to correctly select the charging station providing the maximum monetary gain. For example, comparison at 416 may be based on a loss function that measures a difference between the /edicted/ detected output and training data with labels 414. Based on the comparison at 416 or the corresponding output of the loss function, a training algorithm may update the parameters of machine learning model 410 with the objective of minimizing the differences or loss between subsequent predicted output 412 and corresponding labels 414. By iteratively training in this manner, machine learning model 410 may “learn” from the different training data samples and become better at predicting output 412. In an embodiment, machine learning model 410 is trained using data which is specific to a battery type and different vehicle models using the battery type for predicting adjustments to the settings to provide accurate selection of the charging station and the action (charging or discharging) to be performed with the charging station to maximize monetary gain. In an embodiment, machine learning model 410 is trained using data which is specific to a battery type and different vehicle models using the battery type for predicting adjustments to the settings to provide accurate selection of the charging station and the scheme for heating the vehicle battery with respect to the selected charging station to maximize the monetary gain. In an embodiment, machine learning model 410 is trained using data which is general to the different battery types and is used for predicting adjustments for prediction of the action (charging or discharging) to be performed with the charging station to maximize the monetary gain. In an embodiment, machine learning model 410 is trained using data which is general to the different battery types and is used for predicting adjustments for prediction of the scheme of heating to be executed with the charging station to maximize the monetary gain. In an embodiment, the monetary value may be given weights and provided as an input to the AI/ML system.

Through training, machine learning model 410 may learn to identify predictive and non-predictive features and apply the appropriate weights to the features to optimize detecting and predictive accuracy of machine learning model 410. In embodiments where supervised learning is used and each training data sample has a label, the training algorithm may iteratively process each training data sample and generate a predicted output 412. Any suitable machine learning model and training algorithm may be used, including, e.g., neural networks, decision trees, clustering algorithms, and any other suitable machine learning techniques. Once trained, machine learning model 410 may take input data and select the charging station along with the action (charging/discharging) to be performed with the selected charging station to maximize the monetary gain. In an embodiment, the machine learning model may be trained to take input data and select the charging station along with the scheme to heat the vehicle battery with the respective charging station to maximize the monetary gain. In an embodiment, machine learning model 410 is an artificial neural networks (ANN) model.

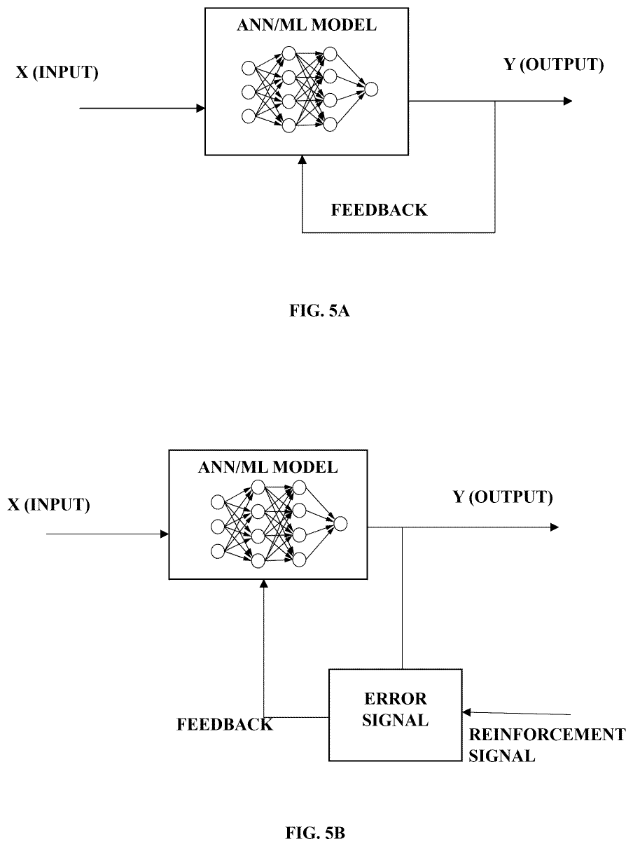

FIG. 5A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises data associated with first predefined value 404, second predefined value 406, charge level/temperature level associated with the vehicle battery 408 and output data may comprise selecting the charging station providing the maximum monetary gain. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may be selection of the charging station and prediction of an action /harging/ discharging) to be performed with the charging station or a heating scheme to be executed with the charging station to maximize monetary gain based on the inputs which may be data associated with first predefined value 404, second predefined value 406, and the charge/temperature level of the vehicle battery 408.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models'performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments needs to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) selection of the charging station (ii) selection of the action (charging/discharging) to be performed with the charging station and (iii) selection of a heating scheme to be executed with the charging station.

FIG. 5B shows a structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In some embodiments, a first machine learning model may take as input any data associated with first predefined value 404, second predefined value 406, charge level associated with the vehicle battery 408 and learn to identify features within the data that are predictive of discharging the vehicle battery or charging the vehicle battery to maximize the monetary gain.

In some embodiments, a second machine learning model may take as input any data associated with first predefined value 404, second predefined value 406, temperature level associated with the vehicle battery 408 and learn to identify features within the data that are predictive of a scheme to heat the battery to the peak performance temperature to maximize the monetary gain associated with heating the battery.

In an embodiment, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment, the machine learning model has a feedback loop, wherein the output from a previous step is fed back to the model in real-time to improve the performance and accuracy of the output of a next step.

In an embodiment, the machine learning model comprises a recurrent neural network model.

In an embodiment, the machine learning model has a feedback loop, wherein the learning is further reinforced with a reward for each true positive of the output of the system.

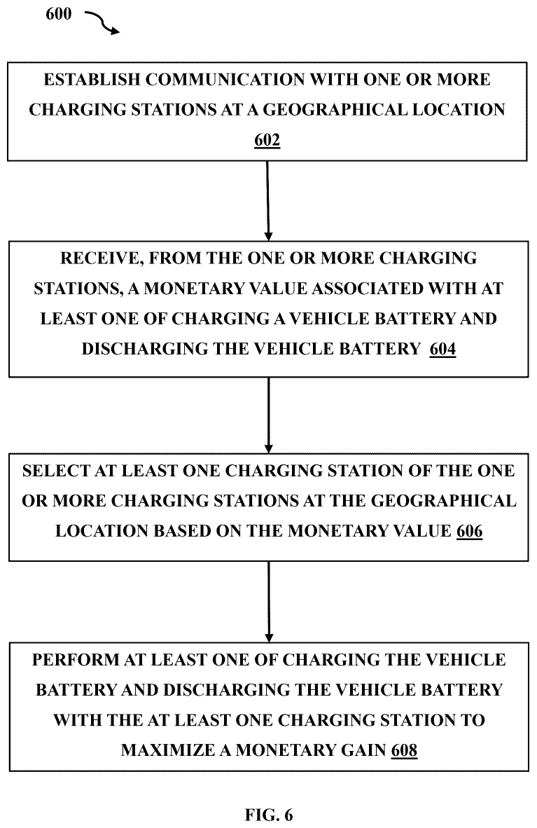

FIG. 6 illustrates a flow chart describing a method for discharging based on monetization opportunity according to an embodiment.

In some embodiments, method 600 may be carried out by a processor using instructions stored in a memory that, when executed, cause the processor to carry out method 600. In an embodiment, method 600 may be performed by system 200 as shown in FIG. 2A.

Referring to FIG. 6, method 600 may, at step 602, establish communication with one or more charging stations at a geographical location. Method 600 may, at step 604, receive, from the one or more charging stations, a monetary value associated with at least one of charging a vehicle battery and discharging the vehicle battery. Method 600 may, at step 606, select at least one charging station of the one or more charging stations at the geographical location based on the monetary value. Method 600 may, at step 608, perform at least one of charging the vehicle battery and discharging the vehicle battery with the at least one charging station to maximize a monetary gain.

In an embodiment, method 600, may further determine whether the monetary value is more than a first predefined value, determine a first charging station of the one or more charging stations providing the monetary value is more than the first predefined value; and connect to the first charging station and discharge the vehicle battery. In some embodiments, the first predefined value is associated with maximizing the monetary gain based on discharging the vehicle battery. In some embodiments, the first predefined value is at least one of user defined or estimated, based on monetary gain obtained from previous discharge cycles.

In an embodiment, method 600, may further monitor an increase in the monetary value based on the monetary value being less than the first predefined value; and discharge the vehicle battery based on the increased monetary value being more than the first predefined value. In an embodiment, method 600, may further determine whether the monetary value is less than a second predefined value; determine a second charging station of the one or more the charging stations providing the monetary value less than the second predefined value; and connect to the second charging station and charge the vehicle battery. In some embodiments, method 600 may further charge the vehicle battery to a 100 percent charge level based on the monetary value being less than the second predefined value. In an embodiment, the second predefined value is associated with maximizing the monetary gain based on charging the vehicle battery. In some embodiments, the second predefined value is at least one of user defined or estimated, based on monetary gain obtained from previous charge cycles.

In an embodiment, method 600 may further determine a charge level associated with the vehicle battery; and establish the communication with the one or more charging stations based on the charge level above a threshold charge level, wherein the threshold charge level is determined based on at least one of a travel route of a vehicle, environmental conditions affecting the vehicle, and efficiency of the vehicle battery.

In an embodiment, the environmental conditions affecting the vehicle comprises at least one of a weather condition and a physical condition associated with the travel route.

In an embodiment, the efficiency of the vehicle battery is based on at least one of charge and discharge current, state of charge, temperature of the vehicle battery, an internal resistance value, and age of the vehicle battery.

In an embodiment, the geographical location comprises a stopover location in the travel route of the vehicle, wherein the stopover location comprises a location where the vehicle is in a stationary state.

In an embodiment, the stopover location comprises at least one of a resting place, a dining place, a parking place, a shopping area, a medical center, and a workshop.

In an embodiment, method 600, may further determine a driver of the vehicle selecting a first stopover location; establish communication with a charging station at the first stopover location and at least one more charging station at a second stopover location; receive a monetary value associated with discharging the vehicle battery from the charging station at the first stopover location and the at least one more charging station at the second stopover location; determine the at least one more charging station at the second stopover location providing a higher monetary value than the charging station at the first stopover location; and indicate to the driver of the vehicle to select the second stopover location to maximize the monetary gain.

In an embodiment, the at least one charging station provides the monetary value more than a first predefined value at a first time period, wherein the first time period comprises a peak time associated with a maximum charge requirement from the at least one charging station.

In an embodiment, the at least one charging station provides the monetary value less than a second predefined value at a second time period, wherein the second time period comprises a valley time associated with a maximum stored charge level present at the at least one charging station.

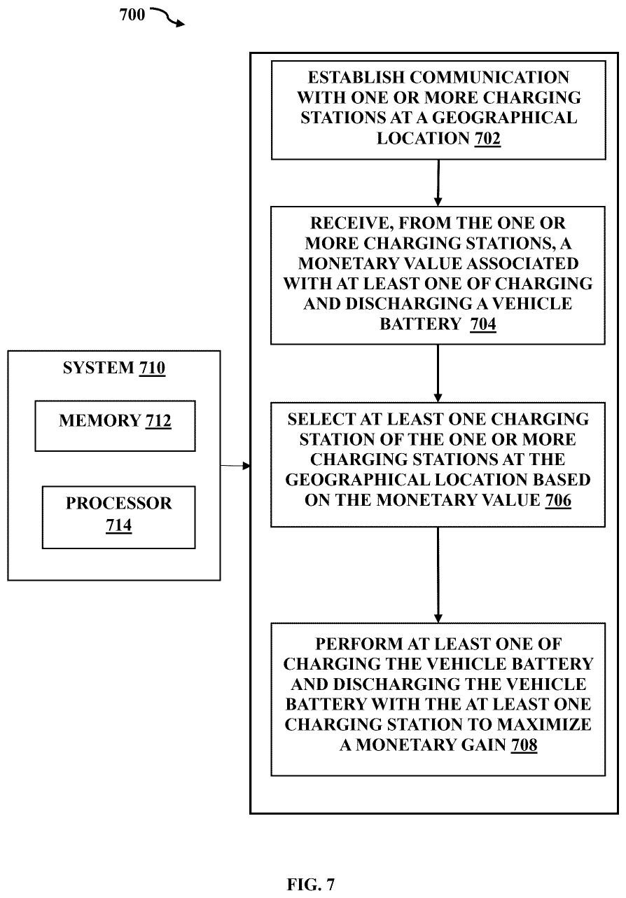

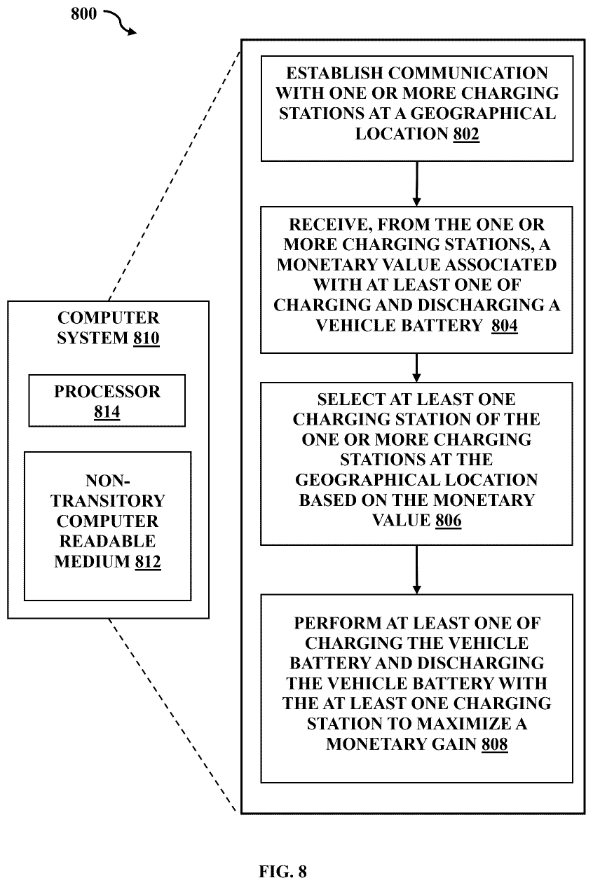

FIG. 7 illustrates block diagram 700 of the system implementing the method for discharging based on monetization opportunity according to an embodiment. According to an embodiment, disclosed is system 710 comprising processor 714; and memory 712, wherein memory 712 storing processor-executable instructions, which on execution, cause the processor to: establish communication with one or more charging stations at a geographical location at step 702; receive, from the one or more charging stations, a monetary value associated with at least one of charging a vehicle battery and discharging the vehicle battery at step 704; select at least one charging station of the one or more charging stations at the geographical location based on the monetary value at step 706; and perform at least one of charging the vehicle battery and discharging the vehicle battery with the at least one charging station to maximize a monetary gain at step 708.

In some embodiments, the processor-executable instructions, which on execution, further cause the processor to determine whether the monetary value is more than a first predefined value; determine a first charging station of the one or more charging stations providing the monetary value more than the first predefined value; and connect to the first charging station and discharge the vehicle battery.

In some embodiments, the processor-executable instructions, which on execution, further cause the processor to monitor an increase in the monetary value based on the monetary value being less than the first predefined value; and discharge the vehicle battery based on the increased monetary value being more than the first predefined value.

In some embodiments, the processor-executable instructions, which on execution, further cause the processor to determine whether the monetary value is less than a second predefined value; determine a second charging station of the one or more charging stations providing the monetary value is less than the second predefined value; and connect to the second charging station and charge the vehicle battery.

In some embodiments, the processor-executable instructions, which on execution, further cause the processor to charge the vehicle battery to a 100 percent charge level or charging to a full capacity based on the monetary value being less than the second predefined value.

In some embodiments, the processor-executable instructions, which on execution, further cause the processor to determine a charge level associated with the vehicle battery, and to establish the communication with the one or more charging stations based on the charge level above a threshold charge level.

FIG. 8 illustrates block diagram 800 of the method executed by the non-transitory computer-readable medium for discharging based on monetization opportunity according to an embodiment.

According to an embodiment, disclosed is computer system 810 comprising non-transitory computer-readable medium 812 having stored thereon instructions executable by processor 814 to perform operations comprising: establishing communication with one or more charging stations at a geographical location at step 802; receiving, from the one or more charging stations, a monetary value associated with at least one of charging a vehicle battery and discharging the vehicle battery at step 804; selecting at least one charging station of the one or more charging stations at the geographical location based on the monetary value at step 806; and performing at least one of charging the vehicle battery and discharging the vehicle battery with the at least one charging station to maximize a monetary gain at step 808.

In some embodiments, non-transitory computer-readable medium 812 further comprises instructions to perform operations comprising: determining whether the monetary value is more than a first predefined value; determining a first charging station of the one or more charging stations providing the monetary value is more than the first predefined value; and connecting to the first charging station and discharging the vehicle battery.

In some embodiments, non-transitory computer-readable medium 812 further comprises instructions to perform operations comprising: monitoring an increase in the monetary value based on the monetary value being less than the first predefined value; and discharging the vehicle battery based on the increased monetary value being more than the first predefined value.

In some embodiments, non-transitory computer-readable medium 812 further comprises instructions to perform operations comprising: determining whether the monetary value is less than a second predefined value; determining a second charging station of the one or more charging stations providing the monetary value is less than the second predefined value; and connecting to the second charging station and charging the vehicle battery.

In some embodiments, non-transitory computer-readable medium 812 further comprises instructions to perform operations comprising: charging the vehicle battery to a 100 percent charge level based on the monetary value being less than the second predefined value.

In some embodiments, non-transitory computer-readable medium 812 further comprises instructions to perform operations comprising: determining, by the processor, a charge level associated with the vehicle battery; and establishing, by the processor, communication with the one or more charging stations based on the charge level being above a threshold charge level.

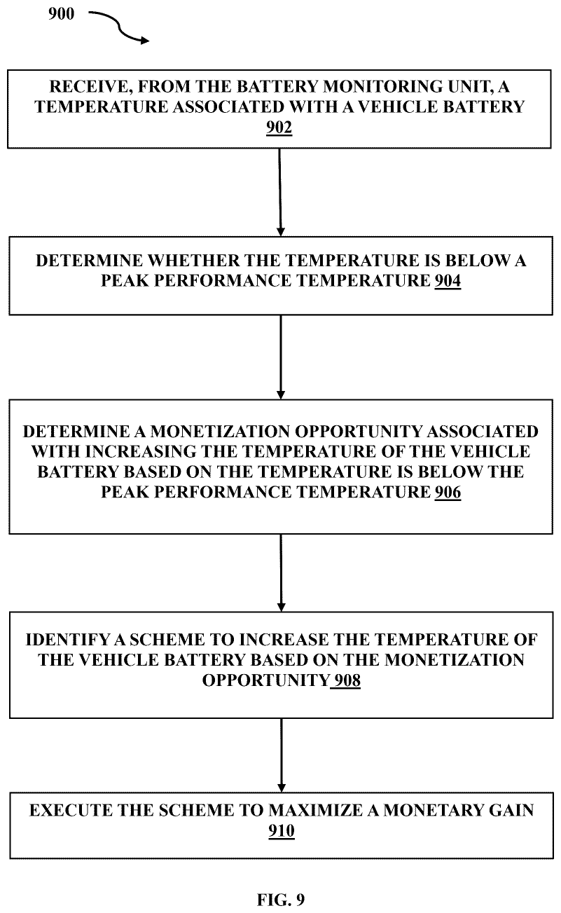

FIG. 9 illustrates a flow chart describing a method to heat a battery for optimal performance according to an embodiment.

Referring to FIG. 9, method 900, may at step 902, receive, from the battery monitoring unit, a temperature associated with a vehicle battery. Method 900, may at step 904, determine whether the temperature is below a peak performance temperature, wherein the peak performance temperature comprises a temperature level associated with the vehicle battery providing a maximized work efficiency. Method 900, may at step 906, determine a monetization opportunity associated with increasing the temperature of the vehicle battery based on the temperature being below the peak performance temperature. Method 900, may further at step 908, identify a scheme to increase the temperature of the vehicle battery based on the monetization opportunity. Method 900, may further at step 910, execute the scheme to maximize a monetary gain.

In an embodiment, method 900 may further establish communication with one or more energy sources; receive from the one or more energy sources an information associated with the monetization opportunity; select at least one energy source from the one or more energy sources based on the monetization opportunity; and connect to the at least one energy source to execute the scheme.

In an embodiment, the information comprises at least one of: a pricing associated with charging the vehicle battery and a pricing associated with discharging the vehicle battery.

In some embodiments, the scheme comprises at least one of: increasing the temperature of the vehicle battery by charging the vehicle battery and increasing the temperature of the vehicle battery by discharging the vehicle battery.

In an embodiment, method 900 may further increase the temperature of the vehicle battery by discharging the vehicle battery based on the pricing associated with discharging the vehicle battery being above a first predefined value.

In an embodiment, method 900 may further determine a charge level associated with the vehicle battery, increase the temperature of the vehicle battery by discharging the vehicle battery based on the charge level being above a threshold charge level, wherein the threshold charge level is determined based on at least one of a minimum charge level required by a vehicle to reach a destination, environmental conditions associated with a travel route of the vehicle, and efficiency of the vehicle battery.

In an embodiment, method 900 may increase the temperature of the vehicle battery by charging the vehicle battery based on at least one of the charge levels is below the threshold charge level, and pricing associated with charging the vehicle battery is below a second predefined value.

In an embodiment, the one or more energy sources are associated with a stopover location along a travel route of a vehicle.

In an embodiment, method 900 may determine a time period associated with increasing the temperature of the vehicle battery to the peak performance temperature; and connect to the at least one energy source associated with the stopover location based on the time period.

In an embodiment, method 900 may determine whether the temperature of the vehicle battery is increased to the peak performance temperature; generate an alert signal based on the temperature of the vehicle battery being equal to the peak performance temperature, receive a response from the user based on the alert signal; and alter the execution of the scheme based on the response.

In an embodiment, method 900 may perform at least one of: continuing with the execution of the scheme; and stop executing the scheme, based on the response.

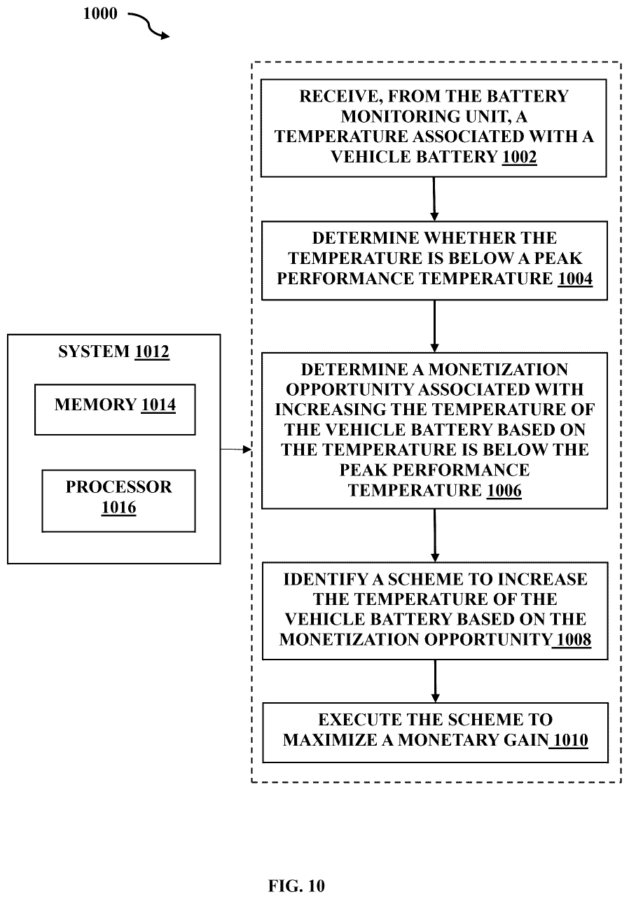

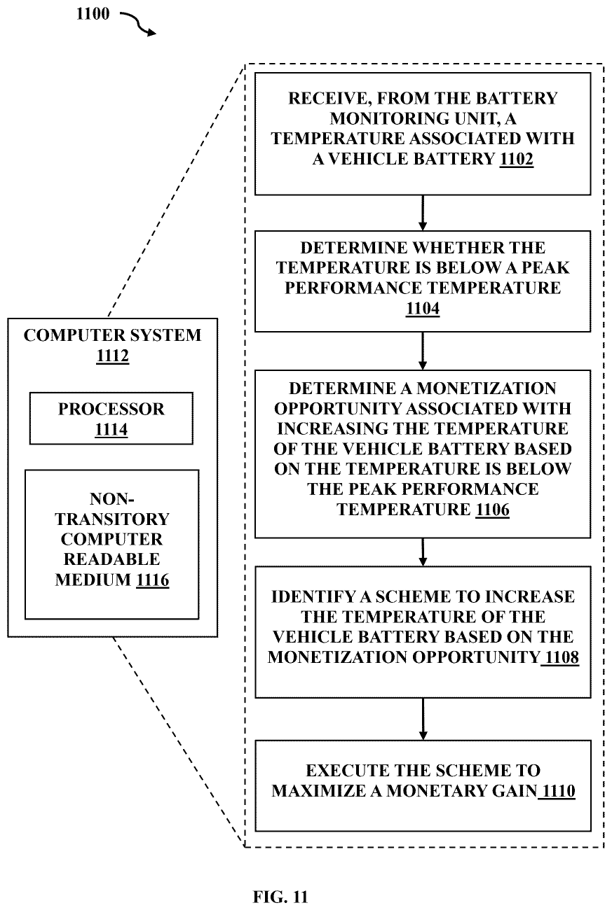

FIG. 10 illustrates block diagram 1000 of the system implementing the method to heat a battery for optimal performance according to an embodiment.

According to an embodiment, disclosed is system 1012 comprising processor 1016; and memory 1014, wherein memory 1014 storing processor-executable instructions, which on execution, causes the processor to: receive, from a battery monitoring unit, a temperature associated with a vehicle battery at step 1002; determine whether the temperature is below a peak performance temperature at step 1004; determine a monetization opportunity associated with increasing the temperature of the vehicle battery based on the temperature being below the peak performance temperature at step 1006; identify a scheme to increase the temperature of the vehicle battery based on the monetization opportunity at step 1008; and execute the scheme to maximize a monetary gain at step 1010.

In some embodiments, the processor-executable instructions, which on execution, further cause processor 1016 to establish communication with one or more energy sources; receive from the one or more energy sources an information associated with the monetization opportunity; select at least one energy source from the one or more energy sources based on the monetization opportunity; and connect to the at least one energy source to execute the scheme.

In some embodiments, the processor-executable instructions, which on execution, further cause processor 1016 to increase the temperature of the vehicle battery by discharging the vehicle battery based on the pricing associated with discharging the vehicle battery being above a first predefined value.

In some embodiments, the processor-executable instructions, which on execution, further cause processor 1016 to determine a charge level associated with the vehicle battery; and increase the temperature of the vehicle battery by discharging the vehicle battery based on the determination that the battery charge level is above a threshold charge level.

In some embodiments, the processor-executable instructions, which on execution, further cause processor 1016 to increase the temperature of the vehicle battery by charging the vehicle battery based on the battery charge level being below the threshold charge level.

In some embodiments, the processor-executable instructions, which on execution, further cause processor 1016 to increase the temperature of the vehicle battery by charging the vehicle battery based on the pricing associated with charging the vehicle battery being below a second predefined value.

In some embodiments, the processor-executable instructions, which on execution, further cause processor 1016 to determine a time period associated with increasing the temperature of the vehicle battery to the peak performance temperature; and connect to the at least one energy source associated with the stopover location based on the time period.

In some embodiments, the processor-executable instructions, which on execution, further cause processor 1016 to determine whether the temperature of the vehicle battery is increased to the peak performance temperature, and to generate an alert signal based on the temperature of the vehicle battery being equal to the peak performance temperature.

In some embodiments, the processor-executable instructions, which on execution, further cause processor 1016 to receive a response from the user based on the alert signal; and alter the execution of the scheme based on the response.

In some embodiments, the processor-executable instructions, which on execution, further cause processor 1016 to perform at least one of continuing with the execution of the scheme; and stopping the execution of the scheme.

FIG. 11 illustrates block diagram 1100 of the method executed by the non-transitory computer-readable medium for heating the battery for optimal performance according to an embodiment.

According to an embodiment, disclosed is computer system 1112 non-transitory computer-readable medium 1116 having stored thereon instructions executable by processor 1114 to perform operations comprising: receiving a temperature associated with a vehicle battery at step 1102; determining whether the temperature is below a peak performance temperature at step 1104; determining a monetization opportunity associated with increasing the temperature of the vehicle battery based on the temperature being below the peak performance temperature at step 1106; identifying a scheme to increase the temperature of the vehicle battery based on the monetization opportunity at step 1108; and executing the scheme to maximize a monetary gain at step 1110.

In some embodiments, non-transitory computer-readable medium 1116 further comprises instructions to perform operations comprising: establishing communication with one or more energy sources; receiving from the one or more energy sources an information associated with the monetization opportunity; selecting at least one energy source from the one or more energy sources based on the monetization opportunity; and connecting to the at least one energy source to execute the scheme.

In some embodiments, non-transitory computer-readable medium 1116 further comprises instructions to perform operations comprising: increasing the temperature of the vehicle battery by discharging the vehicle battery based on the pricing associated with discharging the vehicle battery being above a first predefined value.

In some embodiments, non-transitory computer-readable medium 1116 further comprises instructions to perform operations comprising: determining a charge level associated with the vehicle battery; and increasing the temperature of the vehicle battery by discharging the vehicle battery based on the charge level being above a threshold charge level.

In some embodiments, non-transitory computer-readable medium 1116 further comprises instructions to perform operations comprising: increasing the temperature of the vehicle battery by charging the vehicle battery based on the charge level being below the threshold charge level.

In some embodiments, non-transitory computer-readable medium 1116 further comprises instructions to perform operations comprising: increasing the temperature of the vehicle battery by charging the vehicle battery based on the pricing associated with charging the vehicle battery being below a second predefined value.

In some embodiments, non-transitory computer-readable medium 1116 further comprises instructions to perform operations comprising: determining a time period associated with increasing the temperature of the vehicle battery to the peak performance temperature; and connect to the at least one energy source associated with the stopover location based on the time period.

In some embodiments, non-transitory computer-readable medium 1116 further comprises instructions to perform operations comprising: determining whether the temperature of the vehicle battery is increased to the peak performance temperature; and generating an alert signal based on the temperature of the vehicle battery being equal to the peak performance temperature.

In some embodiments, non-transitory computer-readable medium 1116 further comprises instructions to perform operations comprising: receiving, based on the alert signal, a response from the user; and altering the execution of the scheme based on the response.

In some embodiments, non-transitory computer-readable medium 1116 further comprises instructions to perform operations comprising at least one of: continuing with the execution of the scheme; and stopping the execution of the scheme, based on the response.

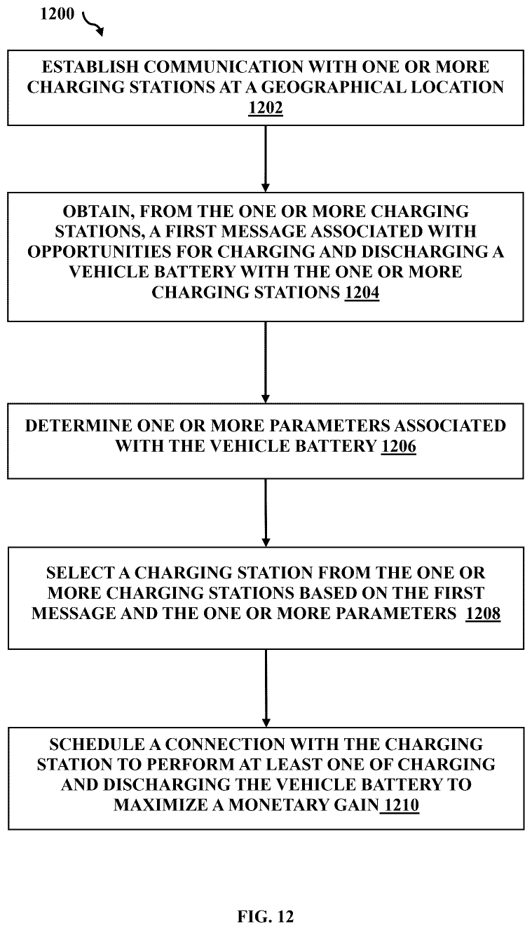

FIG. 12 illustrates a flow chart describing a method of communication with a charging station to identify discharge opportunity according to an embodiment.

Referring to FIG. 12, method 1200 may, at step 1202, establish communication with one or more charging stations at a geographical location. Method 1200 may, at step 1204, obtain, from the one or more charging stations, a first message associated with opportunities for charging and discharging a vehicle battery with the one or more charging stations. Method 1200 may, at step 1206, determine one or more parameters associated with the vehicle battery. Further, method 1200 may, at step 1208, select a charging station from the one or more charging stations based on the first message and the one or more parameters. Method 1200 may, at step 1210, schedule a connection with the charging station to perform at least one of charging and discharging the vehicle battery to maximize a monetary gain.

In an embodiment, the communication comprises a long-range communication, wherein the long-range communication comprises at least one of wireless communication, microwave communication, fiber optic communication, and satellite communication.

In an embodiment, the first message comprises at least one of: a number of chargers associated with the one or more charging stations, number of vehicles connected to the one or more charging stations, amount of charge required at the one or more charging stations, amount of charge required by one or more grids associated with the one or more charging stations, a monetization opportunity, and a duration of the monetization opportunity.

In an embodiment, the monetization opportunity comprises a price per unit of charge provided by the one or more charging stations.

In an embodiment, the price comprises a first price per unit of charge provided by the one or more charging stations for discharging the vehicle battery, wherein the first price per unit of charge is compared with a first predefined value to maximize the monetary gain.

In an embodiment, the duration of the monetization opportunity comprises the first price per unit of charge provided to the one or more charging stations for a first time period.

In an embodiment, the price comprises a second price per unit of charge provided by the one or more charging stations for charging the vehicle battery, wherein the second price per unit of charge is compared with a second predefined value to maximize the monetary gain.

In an embodiment, the duration of the monetization opportunity comprises the second price per unit of charge provided by the one or more charging stations for a second time period.

In an embodiment, the one or more parameters associated with the vehicle battery comprises at least one of a charge level of the vehicle battery and a temperature level of the vehicle battery.

In an embodiment method 1200 may further transmit a second message comprising at least one of the one or more parameters associated with the vehicle battery, a first predefined value, and a second predefined value to the one or more charging stations; and receive a third message from the one or more charging stations, wherein the third message provides an availability of a monetization opportunity at the one or more charging stations based on the second message.

In an embodiment, the first predefined value and the second predefined value are based on the temperature level of the vehicle battery.

In an embodiment, the first predefined value and the second predefined value are based on the charge level of the vehicle battery.

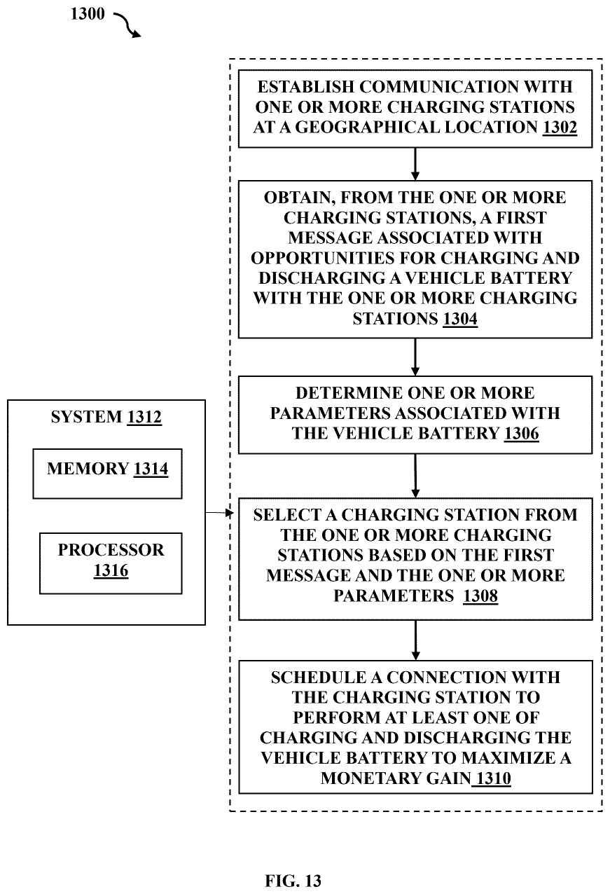

FIG. 13 illustrates block diagram 1300 of the system implementing the method of communication with a charging station to identify discharge opportunity according to an embodiment.

According to an embodiment, disclosed is system 1312 comprising processor 1316; and memory 1314, wherein memory 1314 storing processor-executable instructions, which on execution, cause the processor to: establish communication with one or more charging stations at a geographical location at step 1302; obtain, from the one or more charging stations, a first message associated with opportunities for charging and discharging a vehicle battery with the one or more charging stations at step 1304; determine one or more parameters associated with the vehicle battery at step 1306; select a charging station from the one or more charging stations based on the first message and the one or more parameters at step 1308; and schedule a connection with the charging station to perform at least one of charging and discharging the vehicle battery to maximize a monetary gain at step 1310.

In some embodiments, the processor-executable instructions, which on execution, further cause processor 1316 to transmit a second message comprising at least one of the one or more parameters associated with the vehicle battery, a first predefined value, and a second predefined value to the one or more charging stations; and receive a third message from the one or more charging stations, wherein the third message provides an availability of a monetization opportunity at the one or more charging stations based on the second message.

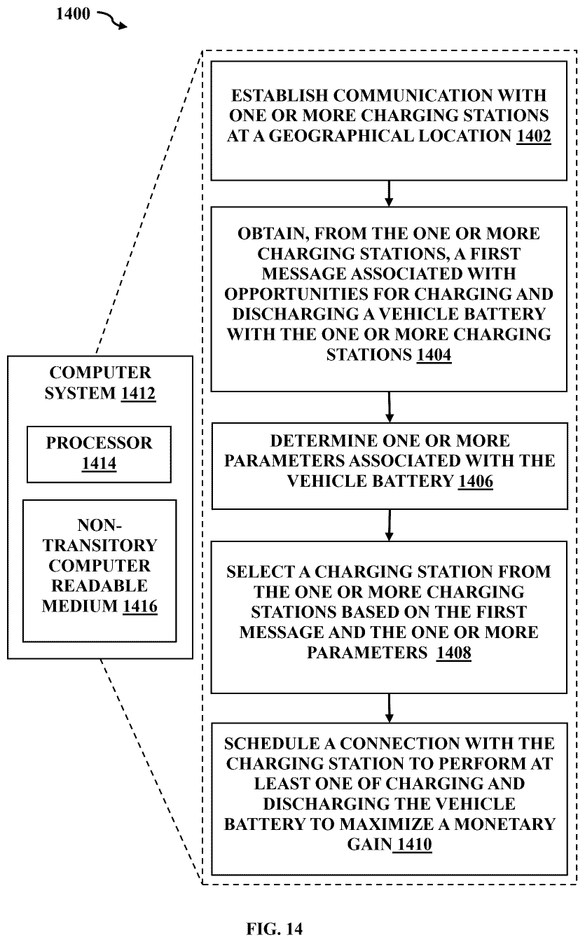

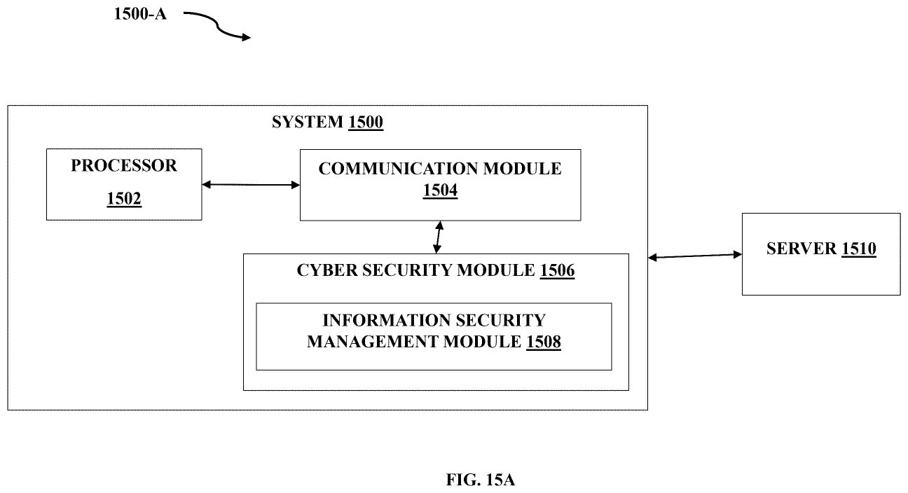

FIG. 14 illustrates block diagram 1400 of the method executed by the non-transitory computer-readable medium for communicating with a charging station to identify discharge opportunity according to an embodiment.

According to an embodiment, disclosed is computer system 1412 comprising non-transitory computer-readable medium 1416 having stored thereon instructions executable by processor 1414 to perform operations comprising: establishing communication with one or more charging stations at a geographical location at step 1402; obtaining from the one or more charging stations, a first message associated with opportunities for charging and discharging a vehicle battery with the one or more charging stations at step 1404; determining one or more parameters associated with the vehicle battery at step 1406; selecting a charging station from the one or more charging stations based on the first message and the one or more vehicle battery parameters at step 1408; and scheduling a connection with the charging station to perform at least one of charging and discharging the vehicle battery to maximize a monetary gain at step 1410.

In some embodiments, non-transitory computer-readable medium 1416 further comprises instructions to perform operations comprising: transmitting a second message comprising at least one of the one or more parameters associated with the vehicle battery, a first predefined value, and a second predefined value to the one or more charging stations; and receiving a third message from the one or more charging stations, wherein the third message provides an availability of a monetization opportunity at the one or more charging stations based on the second message.

FIG. 15A shows block diagram 1500-A of a cyber security module in view of the system and server according to an embodiment.

Referring to FIG. 15A, system 1500 comprising processor 1502, communication module 1504, cyber security module 1506, and information security management module 1508 in communication with server 1510, is shown. The communication of data between system 1500 and server 1510 through communication module 1504 is first verified by information security management module 1508 before being transmitted from system 1500 to server 1510 or from server 1510 to system 1500. Information security management module 1508 is operable to analyze the data for potential cyber security threats, to encrypt the data when no cyber security threat is detected, and to transmit the data encrypted to system 1500 or server 1510.

FIG. 15B shows an embodiment of the cyber security module, in accordance with some embodiments of the present disclosure.

Referring to FIG. 15B, method 1500-B for securing the data through cyber security module 1506 is shown. At step 1512, the information security management module is operable to receive data from the communication module. At step 1514, the information security management module exchanges a security key at a start of the communication between the communication module and the server. At step 1516, the information security management module receives a security key from the server. At step 1518, the information security management module authenticates an identity of the server by verifying the security key. At step 1520, the information security management module analyzes the security key for potential cyber security threats. At step 1522, the information security management module negotiates an encryption key between the communication module and the server. At step 1524, the information security management module receives the encrypted data. At step 1526, the information security management module transmits the encrypted data to the server when no cyber security threat is detected.

FIG. 15C shows another embodiment of the cyber security module, in accordance with some embodiments of the present disclosure.

Referring to FIG. 15C, method 1500-C for securing the data through the cyber security module is shown. At step 1528, the information security management module is operable to: exchange a security key at a start of the communication between the communication module and the server. At step 1530, the information security management module receives a security key from the server. At step 1532, the information security management module authenticates an identity of the server by verifying the security key. At step 1534, the information security management module analyzes the security key for potential cyber security threats. At step 1536, the information security management module negotiates an encryption key between the communication module and the server. At step 1538, the information security management module receives encrypted data. At step 1540, information security management module 1508 decrypts the encrypted data, and performs an integrity check of the decrypted data. At step 1542, information security management module 1508 transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 15A, identity authentication is first carried out on the system and then on the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In some embodiments, the communication between vehicle 302 and charging station 304 as shown in FIGS. 3A and 3B may be secured by the cyber security module. Vehicle 302 may include the communication module coupled to the information security management module. A notification of availability of charge in the vehicle battery may be sent to the charging station through the communication module. In an embodiment, a notification associated with pre-heating the vehicle battery may be sent to the charging station. The notification may be verified by the information security management module before being transmitted from the vehicle to the charging station. The information security management module is operable to analyze the data for potential cyber security threats, to encrypt the data when no cyber security threat is detected, and to transmit the data encrypted to the vehicle or the charging station.

In an embodiment, the charging station may transmit securely at least one of a first message to the vehicle or a third message in response to the second message from the vehicle. The vehicle, upon receiving the information, may determine whether to discharge or charge the vehicle battery to maximize a monetary gain. In an embodiment, the vehicle, upon receiving the information, may select a scheme to heat the vehicle battery to maximize the monetary gain.

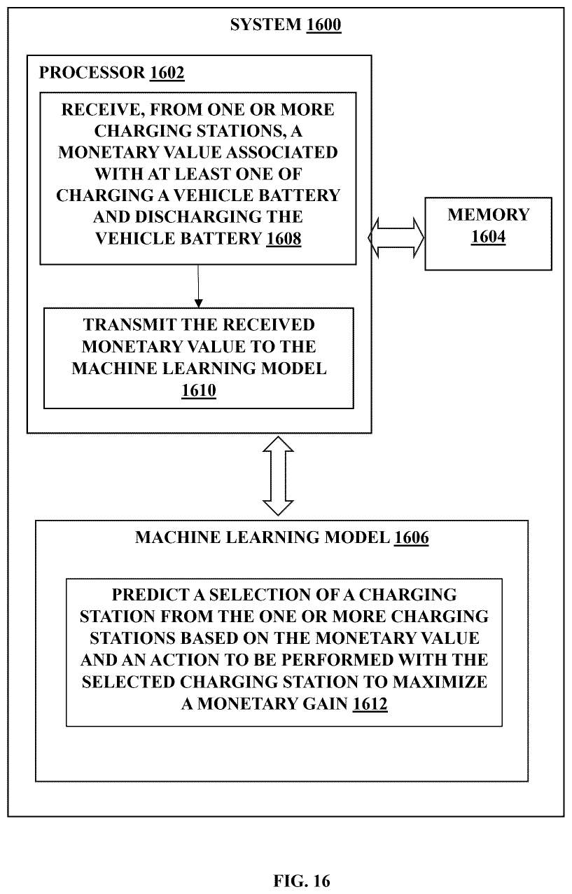

FIG. 16 illustrates a block diagram of a system for discharging or charging the vehicle battery based on monetization opportunity according to an embodiment.

Referring to FIG. 16, system 1600 comprising processor 1602, memory 1604, and machine learning model 1606 is shown. Memory 1604 is operatively coupled to the processor, wherein the memory comprises processor-executable instructions, which on execution, cause the processor to: receive, from one or more charging stations, a monetary value associated with at least one of charging a vehicle battery and discharging the vehicle battery at step 1608; and transmit the received monetary value to the machine learning model at step 1610, wherein the machine learning model is operable to: predict a selection of a charging station from the one or more charging stations based on the monetary value and an action to be performed with the selected charging station to maximize a monetary gain at step 1612.

In an embodiment, the action comprises discharging the vehicle battery with the selected charging station to maximize the monetary gain.

In an embodiment, the action comprises charging the vehicle battery with the selected charging station to maximize the monetary gain.

In an embodiment of system 1600, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of system 1600, the machine learning model is configured to learn from a real-time data using an unsupervised learning method, wherein the unsupervised learning method comprises logic using at least one of a k-means clustering, a hierarchical clustering, a hidden Markov model, and an apriori algorithm.

In an embodiment of system 1600, the machine learning model has a feedback loop, wherein an output from a previous step is fed back to the machine learning model in real-time to improve the performance and accuracy of the output of a next step.

In an embodiment of system 1600, the machine learning model has a feedback loop, wherein the learning is further reinforced with a reward for each true positive of an output of the system.

In an embodiment of system 1600, the machine learning model comprises a recurrent neural network model.

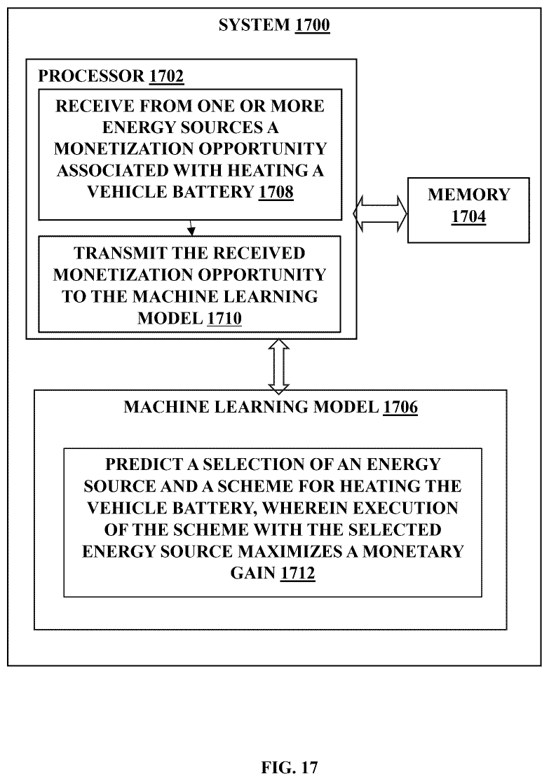

FIG. 17 illustrates a block diagram of a system to heat the vehicle battery for an optimal performance according to an embodiment.

Referring to FIG. 17, system 1700 comprising processor 1702, memory 1704, and machine learning model 1706 is shown. Memory 1704 is operatively coupled to the processor, wherein the memory comprises processor-executable instructions, which on execution, cause the processor to: receive from one or more energy sources a monetization opportunity associated with heating a vehicle battery at step 1708; and transmit the received monetization opportunity to the machine learning model at step 1710, wherein the machine learning model is operable to: predict a selection of an energy source and a scheme for heating the vehicle battery, wherein execution of the scheme with the selected energy source maximizes a monetary gain at step 1712.

In an embodiment, the machine learning model is configured to predict the selection of the energy source and the scheme for heating the vehicle battery based on at least one of a first predefined value, second predefined value, a temperature level, and the received monetization opportunity.

In an embodiment of system 1700, the machine learning model is configured to learn using labelled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment of system 1700, the machine learning model is configured to learn from a real-time data using an unsupervised learning method, wherein the unsupervised learning method comprises logic using at least one of a k-means clustering, a hierarchical clustering, a hidden Markov model, and an apriori algorithm.

In an embodiment of system 1700, the machine learning model has a feedback loop, wherein an output from a previous step is fed back to the machine learning model in real-time to improve the performance and accuracy of the output of a next step.

In an embodiment of system 1700, the machine learning model has a feedback loop, wherein the learning is further reinforced with a reward for each true positive of an output of the system.

In an embodiment of system 1700, the machine learning model comprises a recurrent neural network model.

1-41. (canceled)

42. A system comprising:
a processor operatively coupled to a memory storing instructions which on execution cause the processor to:
establish communication with one or more charging stations at a geographical location;
obtain, from the one or more charging stations, a first message associated with opportunities for charging and discharging a vehicle battery with the one or more charging stations;
determine one or more parameters associated with the vehicle battery;
select a charging station from the one or more charging stations based on the first message and the one or more parameters; and
schedule a connection with the charging station to perform at least one of charging and discharging the vehicle battery to maximize a monetary gain.

43. The system of claim 42, wherein the communication comprises a long-range communication.

44. The system of claim 43, wherein the long-range communication comprises at least one of wireless communication, microwave communication, fiber optic communication, and satellite communication.

45. The system of claim 42, wherein the first message comprises at least one of: a number of chargers associated with the one or more charging stations, number of vehicles connected to the one or more charging stations, amount of charge required at the one or more charging stations, amount of charge required by one or more grids associated with the one or more charging stations, a monetization opportunity, and a duration of the monetization opportunity.

46. The system of claim 45, wherein the monetization opportunity comprises a price per unit of charge provided by the one or more charging stations.

47. The system of claim 46, wherein the price comprises a first price per unit of charge provided by the one or more charging stations for discharging the vehicle battery.

48. The system of claim 47, wherein the first price per unit of charge is compared with a first predefined value to maximize the monetary gain.

49. The system of claim 47, wherein the duration of the monetization opportunity comprises the first price per unit of charge provided by the one or more charging stations for a first time period.

50. The system of claim 46, wherein the price comprises a second price per unit of charge provided by the one or more charging stations for charging the vehicle battery.

51. The system of claim 50, wherein the second price per unit of charge is compared with a second predefined value to maximize the monetary gain.

52. The system of claim 50, wherein the duration of the monetization opportunity comprises the second price per unit of charge provided by the one or more charging stations for a second time period.

53. The system of claim 42, wherein the one or more parameters associated with the vehicle battery comprises at least one of a charge level of the vehicle battery and a temperature level of the vehicle battery.

54. A method comprising:
establishing, by a processor, communication with one or more charging stations at a geographical location;
obtaining, by the processor, from the one or more charging stations, a first message associated with opportunities for charging and discharging a vehicle battery with the one or more charging stations;
determining, by the processor, one or more parameters associated with the vehicle battery;
selecting, by the processor, a charging station from the one or more charging stations based on the first message and the one or more parameters; and
scheduling, by the processor, a connection with the charging station to perform at least one of charging and discharging the vehicle battery to maximize a monetary gain.

55. The method of claim 54, wherein the first message comprises at least one of: a number of chargers associated with the one or more charging stations, number of vehicles connected to the one or more charging stations, amount of charge required at the one or more charging stations, amount of charge required by one or more grids associated with the one or more charging stations, a monetization opportunity, and a duration of the monetization opportunity.

56. The method of claim 55, wherein the monetization opportunity comprises a price per unit of charge provided by the one or more charging stations.

57. The method of claim 56, wherein the price comprises a first price per unit of charge provided by the one or more charging stations for discharging the vehicle battery.

58. The method of claim 56, wherein the price comprises a second price per unit of charge provided by the one or more charging stations for charging the vehicle battery.

59. The method of claim 54 further comprising:
transmitting, by the processor, a second message comprising at least one of the one or more parameters associated with the vehicle battery, a first predefined value, and a second predefined value to the one or more charging stations; and
receiving, by the processor, a third message from the one or more charging stations, wherein the third message provides an availability of a monetization opportunity at the one or more charging stations based on the second message.

60. A non-transitory computer-readable medium having stored thereon instructions executable by a processor to perform operations comprising:
establishing communication with one or more charging stations at a geographical location;
obtaining from the one or more charging stations, a first message associated with opportunities for charging and discharging a vehicle battery with the one or more charging stations;
determining one or more parameters associated with the vehicle battery;
selecting a charging station from the one or more charging stations based on the first message and the one or more parameters; and
scheduling a connection with the charging station to perform at least one of charging and discharging the vehicle battery to maximize a monetary gain.

61. The non-transitory computer-readable medium of claim 60, wherein the instructions further comprise:
transmitting a second message comprising at least one of the one or more parameters associated with the vehicle battery, a first predefined value, and a second predefined value to the one or more charging stations; and
receiving a third message from the one or more charging stations, wherein the third message provides an availability of a monetization opportunity at the one or more charging stations based on the second message.
